(19) United States
(12) Patent Application Publication
(10) Pub. No.: US 2018/0355633 A1
(43) Pub. Date: Dec. 13, 2018

(54) A DOUBLE CYLINDER DEADBOLT LOCK ARRANGEMENT AND ASSEMBLY THEREOF AND A METHOD OF DOOR INSTALLATION OF SAID DOUBLE CYLINDER DEADBOLT LOCK ARRANGEMENT

(71) Applicant: Trio Hinging Australia Pty Ltd., Killburn, South Australia (AU)

(72) Inventors: Eddie Laverty, Kilburn (AU); Colin Horton, Kilburn (AU); Anaru Terei, Kilburn (AU)

(21) Appl. No.: 15/778,550

(22) PCT Filed: Nov. 9, 2016
(86) PCT No.: PCT/AU2016/000373

§ 371 Date: May 23, 2018

(30) Foreign Application Priority Data
Nov. 23, 2015 (AU) 2015904820
Nov. 23, 2015 (AU) 2015904823
Nov. 23, 2015 (AU) 2015904988

(51) Int. Cl. E05B 17/00; E05B 55/00; E05B 63/18; E05B 41/00; E05B 9/08; E05B 55/12

(52) U.S. Cl. CPC E05B 17/005; E05B 55/005; E05B 55/12; E05B 41/00; E05B 9/082; E05B 63/18

(57) ABSTRACT

A double cylinder deadlock lock arrangement including a deadlock control tab slidably supported within an internal housing block such that a segment of said deadlock control tab is extendible out from a peripheral edge of the internal housing block to allow for a user operable engagement with said deadlock control tab, wherein slidable retraction of the extended segment of said deadlock control tab by a user at least substantially into the internal housing block subsequently permits operable rotation of an internal rotatable operable cylinder and/or the external key cylinder when a key is received within the slot of an external key cylinder to move the arrangement from a deadlock lock unlocked position to a deadlock lock locked position.

### TECHNOLOGICAL FIELD

This invention relates to double cylinder deadbolt lock and deadlatch lock arrangements and more particularly to such arrangements that will mitigate the risks in inadvertently deadlocking a door when there are still occupants left within the confines of the deadlocked door.

### BACKGROUND ART DISCUSSION

For the most part double cylinder operated deadlock arrangements will accept keys on both sides of the lock and include a unique locking mechanism wherein the deadbolt or the deadlatch itself is not retractable away from the deadlocked position except when rotating either of the internal or external key cylinders with a key.

A problem with such arrangements that provide a deadlock utilising the double cylinder operable control of both internal and external key cylinders is that if the door was inadvertently deadlocked while occupants remain inside the building, these occupants would not be able to exit out from the deadlocked door unless they had possession of the appropriate key which would be able to engage the internal key cylinder to disengage the deadlock.

Keeping the key within the internal key cylinder of the lock for continuous access by occupants within the building may mitigate against safety risks, but also removes one of the important features associated with double cylinder locks in preventing unwanted unlocking of the door by unauthorised access into the building from another source.

For example if a thief broke into the building and preferred to exit from the deadlocked door if the key remained within the internal key cylinder unlocking of the deadlocked door would be possible.

Accordingly it would be advantageous to be able to provide a double cylinder deadlock arrangement either as a deadbolt or deadlatch that could mitigate against the risks of inadvertently locking the deadlock when there are occupants inside the building and like but also achieve this objective without unduly eliminating one of the benefits of double cylinder deadlocks wherein there remains the requirement of using a key with the internal key cylinder so as to prevent unwanted unlocking of the deadlocked door.

Therefore it is an object of this invention to provide for such a deadbolt lock and/or deadlatch lock arrangement which can substantially ameliorate those problems listed above or at least provide for an improved double cylinder deadlock arrangement that hitherto has yet been made available.

Further objects and advantages of the invention will become apparent from a complete reading of this specification.

### SUMMARY OF THE INVENTION

In one form of the invention there is provided a double cylinder deadlock lock arrangement, said arrangement including;

an internal housing block having an internal rotatable operable cylinder supported therein said internal housing block, wherein a controlled operable rotation of said internal rotatable operable cylinder provides for a deadlock lock unlocked position or a deadlock lock locked position when said arrangement is mounted to a door;

an external housing block with an external key cylinder supported therein said external housing block, wherein a controlled rotation of said external key cylinder when a key is receivable within a slot of said external key cylinder provides for a deadlock lock unlocked position or a deadlock lock unlocked position when said arrangement is mounted to the door;

a deadlock control tab slidably supported within the internal housing block such that a segment of said deadlock control tab is extendible out from a peripheral edge of said internal housing block to allow for a user operable engagement with said deadlock control tab, wherein slidable retraction of the extended segment of said deadlock control tab by a user at least substantially into the internal housing block subsequently permits operable rotation of the internal rotatable operable cylinder and/or the external key cylinder when a key is received within the slot of the external key cylinder to move between a deadlock lock from an unlocked position to a deadlock lock locked position.

In preference the arrangement further includes a deadlock indicator tab slidably supported within the internal housing block such that when the internal rotatable operable cylinder and/or the external key cylinder have been permitted by virtue of the extended segment of the deadlock control tab being retracted substantially into the internal housing block and subsequent rotation to provide a deadlock lock locked position, said deadlock indicator tab is adapted to at least partially extend out from the peripheral edge of said internal housing block to provide a visual and tactile indicator that the arrangement is now in the deadlock lock locked position.

In preference the peripheral edge of said internal housing block to which the extended segment of the deadlock control tab is retractable there into and said deadlock indicator tab is partially extendible out therefrom, is substantially circular.

In preference the deadlock control tab and the deadlock indicator tab are symmetrically arranged on opposing sides of said circular periphery edge of the internal housing block.

In preference the deadlock control tab and the deadlock indicator tab are laterally or vertically arranged on opposing sided.

In preference in one embodiment of the invention when the deadlock indicator tab partially extends out from the peripheral edge of said internal housing block to provide a visual and tactile indicator that the arrangement is in a deadlock lock locked position, the deadlock control tab is adapted to slidably partially extend out from the peripheral edge of said internal housing lock to the pre-retracted position.

In preference the controlled operable operation of the internal rotatable operable cylinder from a deadlock lock unlocked position to a deadlock lock locked position is by a user rotation of an external knob with or without a key adapted to engage within a slot of the internal rotatable operable cylinder.

In preference the controlled operable rotation of the internal rotatable operable cylinder between a deadlock lock locked position and a deadlock lock unlocked position requires an authorised key receivable within the slot of the internal rotatable operable cylinder.

In one embodiment of the invention in preference the deadlock lock is a deadbolt lock.

In a further embodiment of the invention in preference the deadlock lock is a deadlatch lock.

In preference the deadlatch lock requires the latch to be in an extended position from the edge of the door on the arrangement when mounted for the deadlock control tab to be slidably retracted into the internal housing to permit operable rotation of the internal rotatable operable cylinder or the external key cylinder to provide a deadlatch lock locked position.

Advantageously by providing a deadlock control tab for either embodiments of the deadbolt lock or the deadlatch lock means that a conscious decision has to be made in order to place the lock arrangement into the deadlocked position.

If someone is leaving the premises with the intentions of deadlocking the door, that person will have to first of all prime the deadlock lock in order to allow placing the lock into the deadlocked position.

To do this the user must engage the slidably supported deadlock control tab partially extending out from the peripheral edge of the internal housing block.

The user needs to retract that tab back into the internal housing block and by doing this, this will then allow subsequent controlled rotation of either the internal rotatable operable cylinder or the external key cylinder from the deadlock lock unlocked position to the deadlock lock locked position.

Accordingly, security and safety are considered at the time of deadlocking the lock.

Those in a hurry in leaving a building but still wish to provide a deadlock will have to momentarily consider the consequences of deadlocking the door as they slidably retract the deadlock control tab into the internal housing block. It is during this action that the user engaging the double cylinder deadlock lock arrangement can then take stock as to whether or not there are occupants within the building and the associated risks then of deadlocking the door and the like thereafter.

Advantageously, as referred to above, in some preferred embodiments of the invention while the operation of the locking mechanism between a deadlock lock locked position and a deadlock lock unlocked position from the external side of the lock arrangement will always require the use of a key within the external key cylinder, this invention provides for operable control of the internal cylinder simply by rotating a user accessible knob incorporated as part of the internal housing block to take the lock arrangement from the deadlock lock unlocked position to the deadlock lock locked position.

Importantly however so as to then prevent unwanted unlocking of the deadlocked door from within the building subsequently thereafter there will always be the requirement to have an authorised key being received within the internal rotatable operable cylinder for the rotation which sees the lock arrangement going from the deadlock locked position to the deadlock unlocked position.

Advantageously, as introduced above, this invention also in preferred embodiments includes the use of the deadlock indicator tab such that when the lock has been placed into the deadlock locked position at that same time the deadlock indicator tab, because of the way it has been slidably supported and configured within the internal housing block, is able to at least partially extend out from the peripheral edge of the internal housing block to provide a visual and tactile indicator that the lock is now in the deadlock lock locked position.

Accordingly occupants within the building will be able to see both visually and also tactilely by being able to engage the tab that has extended out from the peripheral edge of the internal housing block that the lock is in the deadlock lock locked position.

In some embodiments however the use of the deadlock indicator tab may be optional in that the recognition that the deadlock control tab has been retracted into the internal housing block can in some instances provide an indicator that the deadbolt or deadlatch is in, or at least ready to be in, a deadlock lock locked position.

It is also an object in some forms of this invention to provide the structural arrangement for a deadbolt locking assembly with the requisite user operable trigger mechanism thereof so as to provide for a double cylinder deadbolt lock arrangement that will be able to mitigate against the risk of inadvertently locking the deadbolt lock arrangement when there are occupants inside the building but to achieve this objective without unduly eliminating one of the benefits of double cylinder deadlocks wherein there remains the requirement of using a key within the internal key cylinder to unlock a deadlocked door once locked so as to prevent unauthorised unlocking of the deadbolt lock arrangement by others whom may have enter the building without authority.

Accordingly in a further form of the invention there is provided a deadbolt locking assembly for a double cylinder deadbolt lock arrangement, said assembly including:

a lower housing block adapted to slideably support a user operable deadlock control trigger tab, wherein a segment of the deadlock control trigger tab is extendible out from a peripheral edge of said lower housing block for user operable engagement when said assembly is in a deadbolt unlocked position when a double cylinder deadbolt lock arrangement is mounted to a door to be deadbolt locked;

a deadbolt holding arm pivotally supported within the lower housing block, said deadbolt holding arm biased between a captured position when said deadbolt holding arm is at least partially contained within a deadlock activation tab slideably supported within the lower housing block when said assembly is in a deadbolt unlocked position and an uncaptured biased position wherein the deadbolt holding arm is characterised in being biasable into an assembly deadbolt lock position or biased in the assembly deadbolt locked position;

an upper housing block adapted to be rotatably engageable with said lower housing block;

said upper housing block including an underside profile with a lug extension adapted to rotatably engage with said deadbolt holding arm, wherein rotation of said upper housing block in a first direction relative to the lower housing block enables the lug extension to become biasable in engagement with said deadbolt holding arm to be rotatable from a first position on one side of said deadbolt holding arm to a second side of said deadbolt holding arm, deadbolt holding arm further biased such that when the lug extension has been rotated to the second side of the deadbolt holding arm said assembly is in the deadbolt locked position;

a rotatable deadbolt lock release cam supported within the upper housing block wherein the rotatable deadbolt release cam includes a finger adapted to engage the deadbolt holding arm such that authorised rotation of the deadbolt release cam allows the finger to engage the deadbolt holding arm to bias said deadbolt holding arm into the captured position within the deadlock activation tab thereby allowing rotation of said upper housing block relative to the lower housing block in a second direction for the lug extension to return to the first side of the deadbolt holding arm thereby placing the assembly in a deadbolt unlocked position.

In preference the deadlock activation tab slidably supported within the lower housing block includes a segment that is adapted to at least partially extend out from the peripheral edge of the lower housing block to provide a visual and tactile indicator that the deadbolt locking assembly for the double cylinder deadbolt lock arrangement has the deadbolt in a deadbolt locked position.

In preference the upper housing block on an underside includes a track, guide and/or abutment profiled into the underside which is adapted to engage with a knob and/or raised section extending from the deadlock activation tab such that during relative rotation of the lower housing block with the upper housing block in the first direction so as to place the assembly in a deadbolt locked position, said knob and/or raised section engages the track, guide and/or abutment on the underside of the upper housing block so as to extend out the indicator segment of the deadlock activation tab to provide for the visual and tactile indicator externally to the double cylinder deadlock arrangement so a user is informed that the deadbolt lock is in a deadbolt locked position.

In preference the user operable deadlock control trigger tab includes an untriggered configuration wherein the deadbolt holding arm remains captured within the deadlock activation tab and a triggered configuration wherein the deadbolt holding arm is in the uncaptured position no longer retained within the deadlock activation tab.

In preference the configuration of the deadlock control trigger tab into the trigger configuration produces a lateral slidable engagement between the deadlock control trigger tab and the deadlock activation tab.

In preference the deadbolt holding arm substantially at one end is pivotally supported upon the lower housing block and at a substantially opposing end includes a distal end notch which is able to be received within a receival slot defined within the deadlock activation tab when the deadbolt holding arm is in the captured position.

In preference when the deadlock control trigger tab laterally slidably engages the deadlock activation tab when the deadlock control trigger tab is in the trigger configuration wherein lateral movement of the deadlock activation tab releases the notch of the deadbolt holding arm from the receival slot of the deadlock activation tab so as to bias the deadbolt holding arm away from the captured position to the uncaptured position.

In preference the deadbolt holding arm includes a raised shoulder wherein an external skirt or edge of the raised shoulder provides for an interconnected engagement between a stem extending from the finger of the deadbolt release cam such that rotation of the deadbolt release cam in the second direction causes the interconnection engagement between the stem of the finger attached to the deadbolt release cam and the shouldered skirt or edge of the raised shoulder of the deadbolt holding arm to bias the deadbolt holding arm back into the captured position within the deadbolt activation tab.

In preference the deadlock activation tab is in communication with a resilient spring biasing the deadlock activation tab to allow the receiving slot of the deadlock activation tab to slidably return to its receival engagement configuration with the deadbolt holding arm, when the deadbolt holding arm is returned to its captured position by the deadbolt release cam.

In order to establish such a distinct locking mechanism for the embodiments introduced above there could be a significant amount of components associated with the locking mechanism per se, which in conventional double cylinder deadbolt lock arrangements requires the internal and/or external key cylinders to be intricately entwined there within the locking mechanism for operable actioning of the lock.

As either or both of the internal and external key cylinders are so intricately involved in the workings of the locking mechanism of the deadbolt lock arrangement, it often makes the design of the deadbolt lock quite cumbersome being made up of almost a jigsaw combination of housing, fastening features and locking mechanisms for which an installer must be skilled enough to bring together into the correct configuration to then appropriately align, mount and make operational the double cylinder deadbolt lock arrangement within a door for which the lock will responsible for locking and unlocking with a deadbolt lock functionality.

It would be particularly advantageous if it was possible to present to an installer a much more simplified and streamlined design of a double cylinder deadbolt lock arrangement that left the installer, without the requirement of setting any components within operable positioning, and for the most part simply require the installer to take an internal housing block, an external housing block and a bolt assembly from it's supplied packaging to be then able to conveniently mount these parts to the door without having to pre-position, assemble, align, activate or the like, the locking mechanism of the deadbolt lock, as the mounting together of the respective internal housing block, external housing block and the bolt assembly to the door automatically result in an operational deadbolt lock arrangement once the pieces have been positioned and fastened relative to the other to the door.

It would also be particularly advantageous if it was possible to provide such an easy to install, double cylinder deadbolt lock arrangement having three identifiable independent pieces, notably the internal housing block, external housing block and the bolt assembly wherein both the internal and external key cylinders are accessible through a sub-assembly arrangement arrangement of the respect of the respective internal and external housing blocks without interrupting, dislodging or coming in contact with the internal locking mechanisms of the deadbolt lock arrangement thereby allowing locksmiths and the like convenient accessibility to each of the internal and external key cylinders when key lock changes are required.

As introduced above many conventional locks require that the internal and external key cylinders be intricately linked with the other components that establish the locking mechanism thereby if a locksmith or the like needs to access either or both of these internal and external key cylinders the locksmith will need to disassemble many of the other features of the locking mechanism in order to access and extricate the internal or external key cylinder for the changing of the key details.

If the locking mechanism components need to be disassembled to access the internal or external key cylinder, not only does this make the task of getting access to the internal or external key cylinder more troublesome for a locksmith, but also introduces potential ultimate deadbolt lock integrity issues when the locksmith has to reposition back in place the internal and/or external key cylinder with those components making up the locking mechanism which if not correctly reassembled can result in malfunctioning or non-operation of the deadbolt lock arrangement.

Hence in a further form of the invention there is provided a double cylinder deadlock lock arrangement, said arrangement including:

an internal housing block including a sub-assembly arrangement, said internal housing block sub-assembly arrangement including an internal cylinder housing enclosure having an external profile adapted for user rotation and said internal cylinder housing enclosure having an internal profile for operably retaining therein an internal key cylinder;

a main internal housing body wherein said internal cylinder housing enclosure is fastenable thereto, said main internal housing body characterised by enclosing a deadbolt lock locking arrangement and providing an external rotatable support for said internal key cylinder wherein when the internal cylinder housing enclosure is fastened to the main internal housing body, rotation of said internal key cylinder is adapted to in part control said deadbolt lock locking arrangement;

said main internal housing body further characterised by a pair of tab extensions, wherein a spacing between the pair of tab extensions allows the internal housing block to be locatable and in alignment about a bolt assembly when said internal housing block and bolt assembly are mounted upon a door;

an external housing block with a sub-assembly arrangement including an external cylinder housing enclosure having an internal profile adapted to operably retain an external key cylinder, a main external housing body wherein said external cylinder housing enclosure is fastenable thereto, said main external housing body characterised with an external operable rotatable support of said external key cylinder, said external key cylinder in operable communication with a spring biased spindle, wherein said spring biased spindle is configured to pass through said bolt assembly and engage an external receivable slot of said main internal housing body when said external housing block is fixed thereto the internal housing block when said internal housing block is mounted to a door such that when said spring biased spindle is received within the external slot of said main internal housing body said spring biased spindle operably engages said deadbolt lock locking arrangement to control said bolt assembly;

such that when the double cylinder deadlock lock arrangement is mounted to a door, the main internal housing body is fastened on an internal side of the door and partially within a first bore hole defined in the door with the pair of tab extensions located and positioned about the top and bottom of the bolt assembly, wherein said bolt assembly is fixed within a cross-bore hole from an edge of the door, and wherein the external housing block is fastened to an external side of the door and partially within the first bore hole supported by fixing screws supported by the main internal housing block when mounted to the internal side of the door such that the spring biased spindle is in operable engagement with the deadbolt lock locking arrangement to control said bolt assembly.

An advantage of such an arrangement is that this unique double cylinder deadbolt lock provides for a simple three part design wherein the installer needs only to position and mount the deadbolt assembly in the cross-bore from the edge of the door frame to then conveniently have the internal housing block mounted on the internal side of the door and partially within the main bore where it is appropriately located and aligned relative to the bolt assembly by the protruding pair of tab extensions.

The external housing block is then able to be conveniently and securely mounted to the external side of the door through fixing screws and the like which are supported by the internal housing block which has been mounted to the internal side of the door.

Advantageously as the spindle which is able to be received within the external slot of the main internal housing body in order to access the deadbolt lock locking mechanism is spring biased, means that the three part deadbolt lock arrangement can work with doors having different depths.

As the three part sections are taken from the packaging there would be no requirement for the installer to then have to interrupt internal mechanisms of the deadbolt lock arrangement by trying to adjust therein a spindle of an appropriate length to match the depth of the door to which the deadbolt lock arrangement is being mounted thereto.

By having a spring biased spindle allows for an inherent adaptability to handle doors of different depths so the deadbolt arrangement will not need to be provided with a whole series of different spindle lengths where an installer will have to match the right length from a selection of lengths with the depth of the door or alternatively have to cut a longer length spindle to a reduced size should the door be of less depth.

Complexities of installation have been removed by incorporating a spring biased spindle within the main external housing body of the external housing block.

When the installer wishes to install the deadbolt lock there is no pre-assembly of internal working componentry and parts to make the deadbolt lock operable once mounted to the door.

Advantageously the deadbolt lock arrangement becomes functionally operable simply by putting together the three independent pieces of the internal housing block, bolt assembly and external housing block as referred to above.

Still further, advantageously this invention also utilises sub-assembly arrangement configurations for both the internal housing block and the external housing block wherein the sub-assemblies still avoids any necessity for an installer or user to have to re-position any part relative to another in order to bring about deadbolt lock functionality.

The purpose of providing a sub-assembly arrangement configuration for both the internal housing block and the external housing block is that it will allow easy and convenient access to both the internal and external key cylinders without having to interrupt any of the overall internal locking mechanism components.

In the case of the internal key cylinder, as the internal cylinder housing enclosure includes the internal profile to operably retain the internal key cylinder which is then able to rest upon a corresponding external rotatable support of the main internal housing body means that all one has to do in order to gain access to the internal key cylinder is to simply dismantle the internal cylinder housing enclosure from the main internal housing block. When these two parts of the internal cylinder housing enclosure and the main internal housing body are separated, there is no disengagement or falling apart of other parts and components making up the deadbolt lock locking mechanism. The separation simply allows for convenient access to the internal key cylinder for key reconfiguration and the like.

The same similar scenario is presented in the sub-assembly arrangement associated with the external housing block wherein dismantling the external cylinder housing enclosure with the internal profile which is adapted to operably retain the external key cylinder from the main external housing body, is that once these two parts are separated access becomes available to the external key cylinder without having to interrupt any of the operations, configuration and componentry associated with the spring biased spindle which is housed and contained within the main external housing body.

In preference the sub-assembly arrangement of the main internal housing body includes a lower section with a peripheral collar to which said pair of tab extensions extend therefrom.

In preference the lower section of the main internal housing body peripheral collar is of a depth so as to circumferentially engage within first bore hole defined in the door.

In preference the external receivable slot of the main internal housing body includes a longitudinal rotatable slot of dimensions comparable to a distal end of the spring biased spindle.

In preference the bolt assembly includes a rotatable bolt controller including a slot of comparable dimensions to the distal end of said spring biased spindle such that when the external housing block is fixable to the main internal housing block the spring biased spindle is adapted to pass through the slot of bolt controller in the bolt assembly to be received within the external receivable slot of the main internal housing body so as to operably engage the deadbolt lock locking arrangement.

In preference the spring biased spindle is supported within the sub-assembly arrangement of the main external housing body by a raised rotatable platform.

In preference the raised rotatable platform includes a pair of leg extensions which are adapted to rotate along the external operable rotatable support of the external key cylinder of the main external housing body such that rotation of the external key cylinder allows a rotation of the pair of leg extensions of the raised platform confining said spring biased spindle so as to translate said rotational movement to corresponding rotational movement of said spring biased spindle.

Advantageously the spring biased spindle is allowed to rotate laterally as a consequence of engagement of the external key cylinder with the leg extensions of the raised platform. The actual biasing of the spring at the base of the spindle enables the spindle to be resiliently pushed in and out within the sub-assembly arrangement of the main external housing body so that it can be of appropriate length to be able to pass through the rotatable slot of the bolt assembly and then into the receivable slot within the main internal housing body so as to engage the locking mechanism contained therein.

Depending on the depth of the door will then be relative to the degree in which the spring biased spindle will extend out therefrom the main external housing body.

In preference the main external housing body includes an upper section wherein the circumferential diameter of the upper section is such so as to allow the upper section to circumferentially rest within the first bore hole defined within the door.

In preference a lower section of the main external housing body includes a separate circular base plate and a raised block.

In preference the circular base plate includes a series of fastening holes which correspond to grooves longitudinally configured along the raised block and which also correspond to fastening holes of the external cylinder housing enclosure operably retaining the internal key cylinder such that the sub-assembly arrangement of the external housing block are fixable together.

In preference a fixing of the external housing block to the main internal housing block includes two fastening screws or bolts positionable along definable pathways wherein said fastening screws or bolts include a flat resting head, restable upon the raised collar of the main internal housing body with the opposing terminal distal ends of said screws or bolts engaging corresponding slots defined within the external cylinder housing enclosure retaining the operable external key cylinder.

In preference the holes to receive the fastening screws or bolts between the main internal housing block and external housing block include identifiable markers.

An advantage of such an arrangement is that the installer is able to recognise the location for fastening and fixing screws between the internal housing block and the external housing block as opposed to the separation and access between sub-assembly arrangement parts of the internal and external housing blocks.

In preference the main internal housing block further includes an external circular shouldered enclosing plate so that once the double cylinder deadbolt lock arrangement has been mounted to the door the raised collar with the fixed screws or bolts positioned therein can be covered thereby said external circular shouldered enclosing plate providing an improved aesthetic appearance.

In order now to describe the invention in greater detail a series of preferred embodiments will be described with the assistance of the following illustrations and accompanying text.

### BRIEF DESCRIPTION OF THE DRAWINGS

FIG. 1 is a perspective view of a preferred embodiment of the invention showing a deadbolt lock arrangement mounted to a door.

FIGS. 2 to 9 show various schematic representations of the double cylinder deadlock lock arrangement as a deadbolt lock arrangement and various operations thereof in preferred embodiments of the invention.

FIGS. 10 to 14 show various schematic representations of preferred embodiments of the invention associated with the Lock arrangement as a double cylinder deadlatch lock arrangement and in some instances operations thereof.

FIG. 15a is a perspective view of the three main parts of the double cylinder deadbolt lock arrangement in a preferred embodiment of the invention.

FIG. 15b is a part exploded view of the same blocks listed in FIG. 1a in a preferred embodiment of the invention.

FIG. 16 is a perspective view of the internal housing block in a preferred embodiment of the invention.

FIG. 17 is an exploded view of the internal housing block as shown in FIG. 16.

FIG. 18a is a perspective view of the user rotatable knob and FIG. 18b is a view looking into the internal profile of the internal cylinder housing enclosure in a preferred embodiment of the invention.

FIG. 19 is a perspective view of an internal key cylinder.

FIG. 20 is a perspective view of the sub-assembly arrangement part of the main internal housing body of the internal housing block in a preferred embodiment of the invention.

FIG. 21 is a perspective view of the external housing block in a preferred embodiment of the invention.

FIG. 22 is an exploded perspective view of FIG. 21.

FIG. 23 is an underside view of the main external housing body sub-assembly arrangement of the external housing block.

FIG. 24 is a perspective view of the external key cylinder housing enclosure.

FIG. 25 is a general view looking in at the inner profile of the external key cylinder housing enclosure.

FIG. 26 is a perspective view similar to that shown in FIG. 15a with the three main parts of the internal housing block, bolt assembly and external housing block closer together.

FIGS. 27, 28, and 29 show various representations of the double cylinder deadbolt lock arrangement mounted to a door in a preferred embodiment of the invention.

FIGS. 30a and 30b are perspective views of the three main blocks or parts of a double cylinder deadlock arrangement, the kinds of which the deadbolt locking assembly of this invention would be incorporated there into.

FIG. 31 is a general view looking down upon the lower housing block of the deadbolt locking assembly in a preferred embodiment of the invention.

FIG. 32 is a general perspective view looking at the upper side of the upper housing block of the deadbolt locking assembly in a preferred embodiment of the invention.

FIG. 33 is a perspective view of the same upper housing block shown in FIG. 3 but looking from the underside of the upper housing block.

FIGS. 34a, 34b, 34c and 34d show various schematic representations of the deadbolt locking assembly in a deadbolt unlocked position.

FIGS. 35a, 35b, 35c and 35d show various schematic representations of the deadbolt locking assembly in a triggered and/or primed deadbolt unlocked position.

FIGS. 36a, 36b, 36c and 36d show the deadbolt locking assembly in a preferred embodiment of the invention in a deadbolt locked position.

FIG. 37 shows the deadbolt release cam in a preferred embodiment of the invention.

### DETAILED DESCRIPTION OF THE DRAWINGS

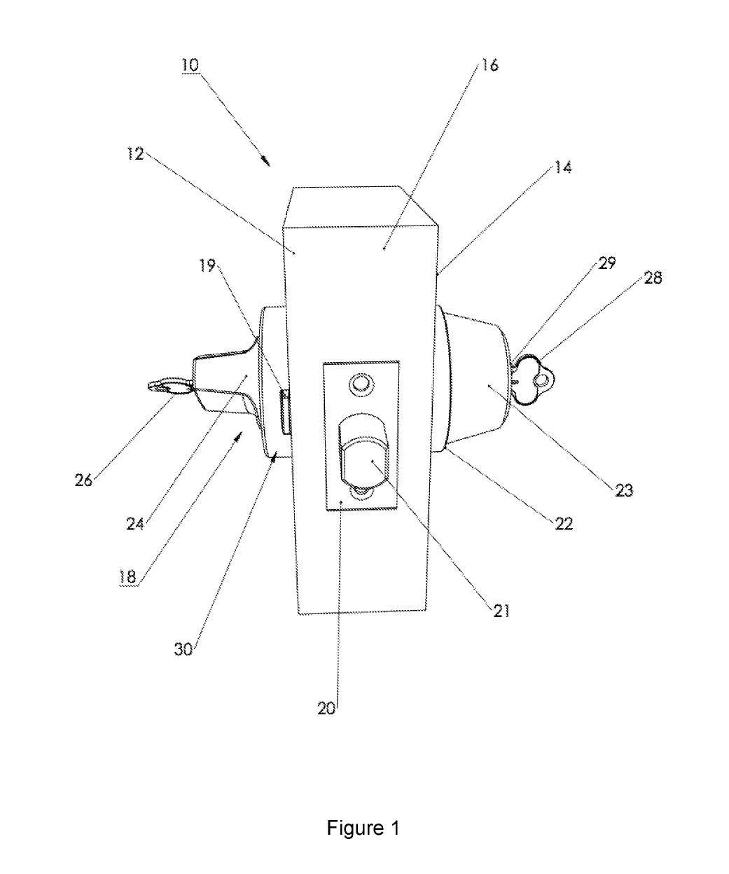

Referring now to the drawings in greater detail FIG. 1 shows the mounting of a double cylinder deadbolt lock arrangement to a door shown generally as (10).

The door includes an internal side (12), external side (14) and a door edge (16).

The double cylinder deadbolt lock arrangement includes an internal housing block shown generally as (18), a bolt assembly shown generally as (20) and an external housing block assembly shown generally as (22).

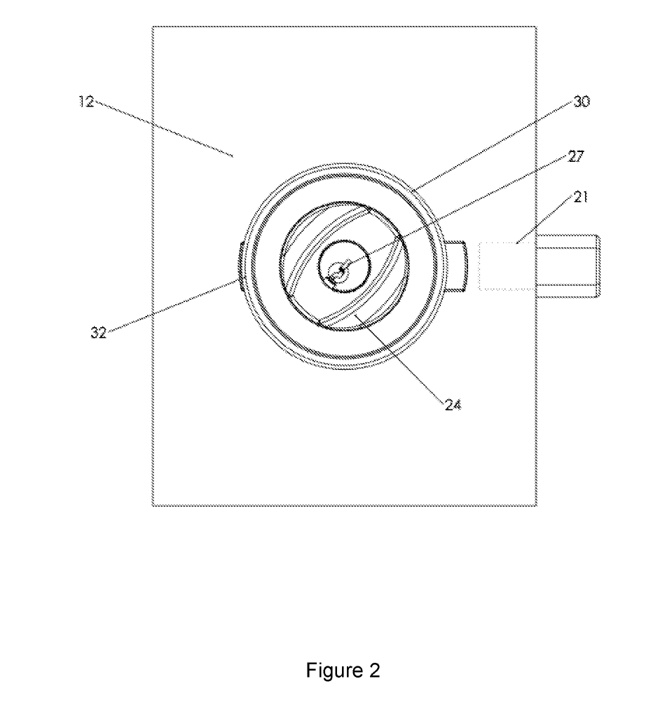

As best seen in FIG. 2 the internal housing block (18) includes deadlock control tab (32) extending out from the circular peripheral edge (30) of the internal housing block (18).

In FIG. 2 the deadlock control tab (32), which is slidably supported within the internal housing block (18) and extends out through slot (19), provides a user with an engageable section (32), again as best seen in FIG. 2.

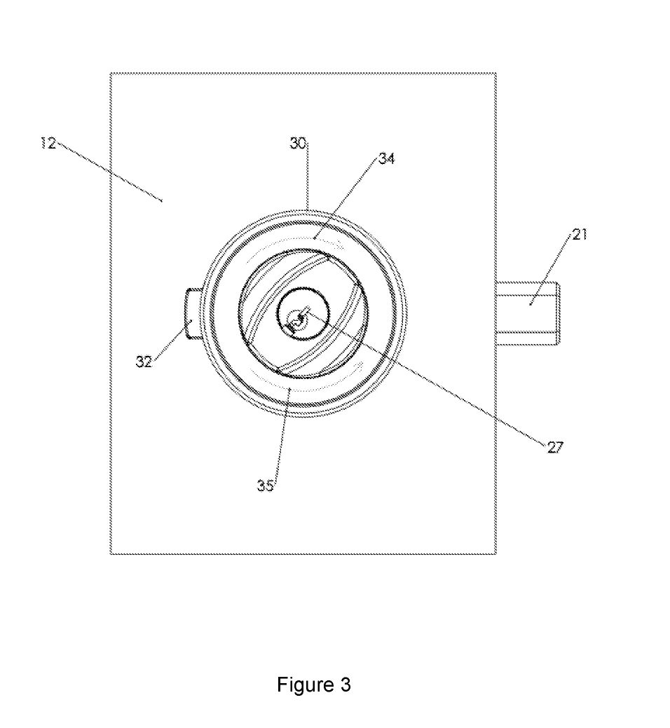

FIG. 2 shows the double cylinder deadbolt lock arrangement in a deadbolt lock unlocked position where the bolt, shown in FIG. 1 and FIG. 3 as (21) when extended, is in a retracted position inside the edge of the door (16) and therefore is viewable as dashed lines (21) in FIG. 2.

As the deadlock control tab segment (32) extending out from the peripheral edge (30) of the internal housing block (18) has not been retracted back within the internal housing block (18) this means that the internal locking mechanism of the lock arrangement is not primed to allow the double cylinder deadbolt lock arrangement to be moved into a deadbolt lock locked position even if as seen in FIG. 1 an authorised key (28) is received within a key slot (29) of an external key cylinder supported within the main body (23) of the external housing block (22).

Also as best seen in FIG. 3, if the knob (24) is rotated, shown by way of arrow (34), with or without a key (26) inserted into the slot (27) so as to engage the internal rotatable operable cylinder while the bolt (21) will be thrown to lock the door the double cylinder deadbolt lock arrangement will however while being locked not be in a deadbolt lock locked position as subsequent rotation of the user controllable knob (24) of the internal housing block (18) shown by way of arrow (35) will allow the corresponding retraction of the bolt (21) back into the edge (16) of the door (10).

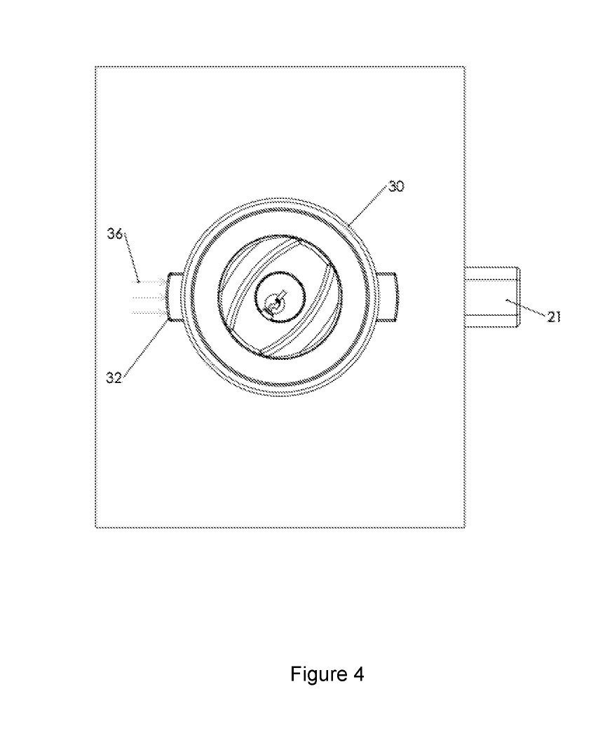

In order to be able to have the double cylinder deadbolt lock arrangement in a status of a deadbolt lock locked position there is the requirement for the deadlock control tab segment (32) shown by way of arrows (36) in FIG. 4 to be pushed within the internal housing block (18), which in the preferred embodiment would be a retraction of the tab (32) back through slot (19) on the peripheral edge (30).

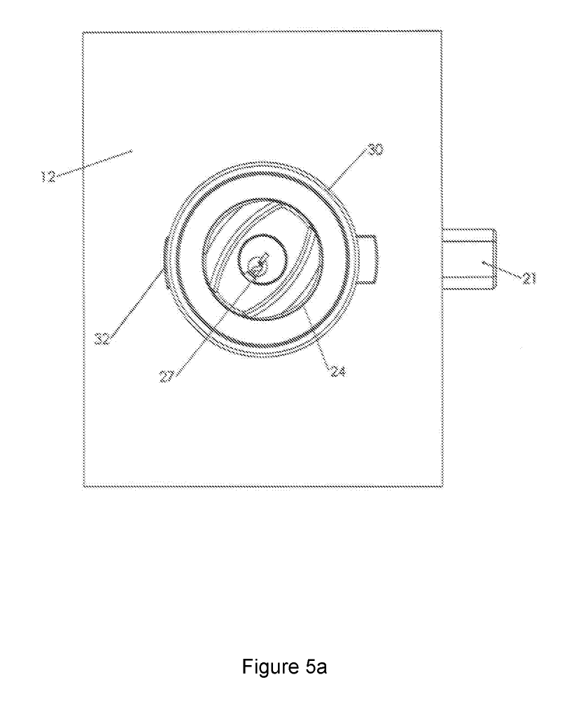

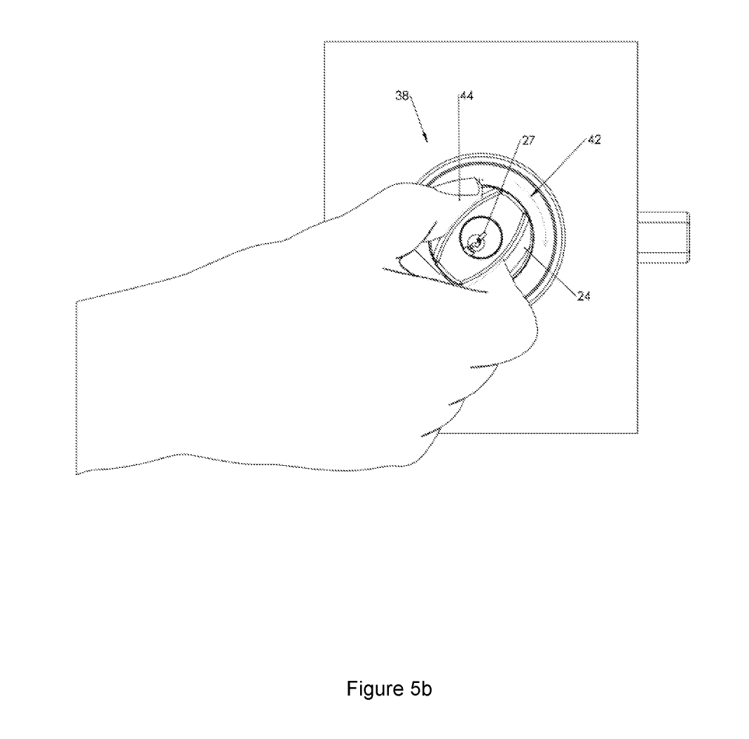

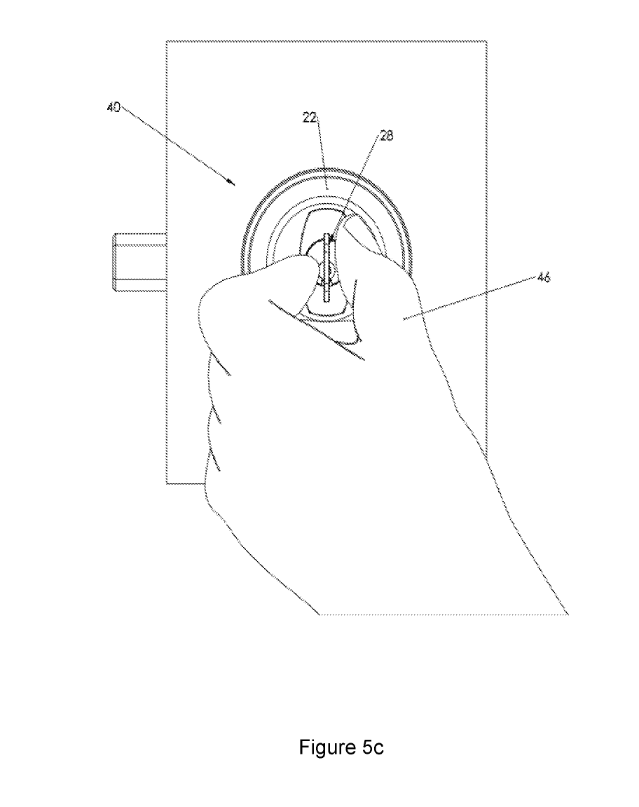

As best seen in FIGS. 5a to 5c, now that the deadlock control tab extended segment (32) has been engaged by the user and pushed back within the internal housing block (18) the double cylinder deadbolt lock arrangement can be placed into the deadbolt lock locked position from the scenarios illustrated either from the inside shown generally as (38) (FIG. 5b) or the outside (40) (FIG. 5c).

In the scenario shown for the inside (38) (FIG. 5b), a user's hand (44) can access the rotatable knob (24) without a key inserted into the slot (27) which engages the internal rotatable operable cylinder (not shown) that engages the locking mechanism within the internal housing block (18) and upon rotation shown by arrow (42) brings about lock status from a deadbolt lock unlocked position to a deadbolt lock locked position.

Hence in the preferred embodiment shown in FIGS. 5a to 5c, a user need not have to utilise an authorised key, which in FIG. 1 is shown as (26), but providing the deadlock control tab (32) has been slid or pressed back into the internal housing block (18) this then structurally inherently activates the internal lock mechanism such that subsequent rotation of the knob (24) shown by way of arrow (42) will take the status of the bolt (21) to a deadbolt lock locked position.

As shown in FIG. 5c, the deadbolt lock locked position can also be achieved by rotation of an authorised key (28) from the external housing block (22), which engages the external key cylinder (not shown) supported in the main body (23) of the external housing block (22), which communicates with the double cylinder deadbolt lock mechanism which is permitted upon rotation of the key (28) given that the deadlock control tab (32) has been pushed within the internal housing block (18) to be rotatable to provide for a deadbolt lock locked position.

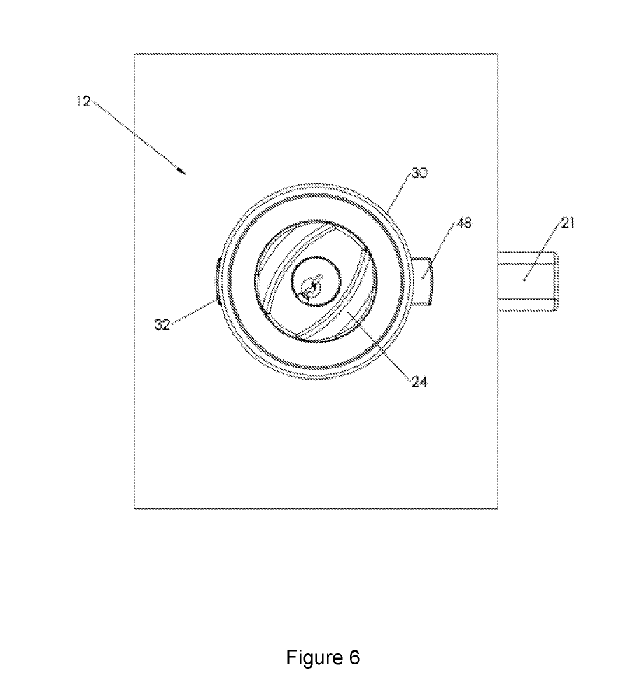

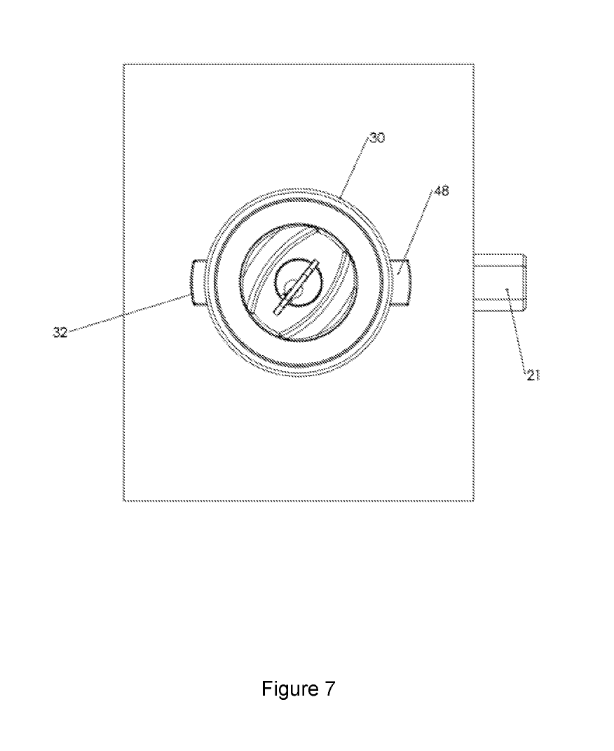

FIGS. 6 and 7 both illustrate alternative preferred embodiments of what happens once the double cylinder deadbolt lock arrangement has moved to a deadbolt lock locked position.

As seen in FIG. 6 a deadlock indicator tab (48) has extended out from the peripheral edge (30) of the internal housing block (18).

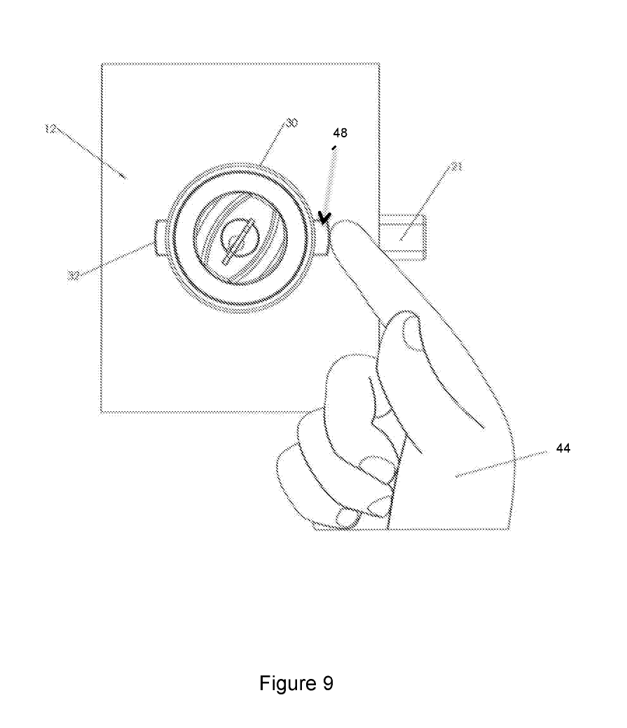

The deadlock indicator tab (48) provides both a visual and tactile indicator that the deadbolt lock arrangement is in the deadbolt lock locked position. FIG. 9 shows a similar representation to that shown in FIG. 6 where the hand (44) of a user is able to recognise that the deadbolt lock is in the deadbolt lock locked position because the hand (44) is able to feel the actual tab extension (48) of the deadlock indicator tab (48) as it is now extended out from the peripheral edge (30) of the internal housing block (18).

Hence if an occupant inside the building was blind and could not see, the deadlock indicator tab still provides a tactile reference to show that the double cylinder deadbolt lock arrangement is in the deadbolt lock locked position.

FIG. 7 shows the scenario that as the deadlock indicator tab (48) extends out as the lock goes to the deadbolt lock locked position, the deadlock control tab (32) simultaneously extends out from the peripheral edge (30) of the internal housing block (18).

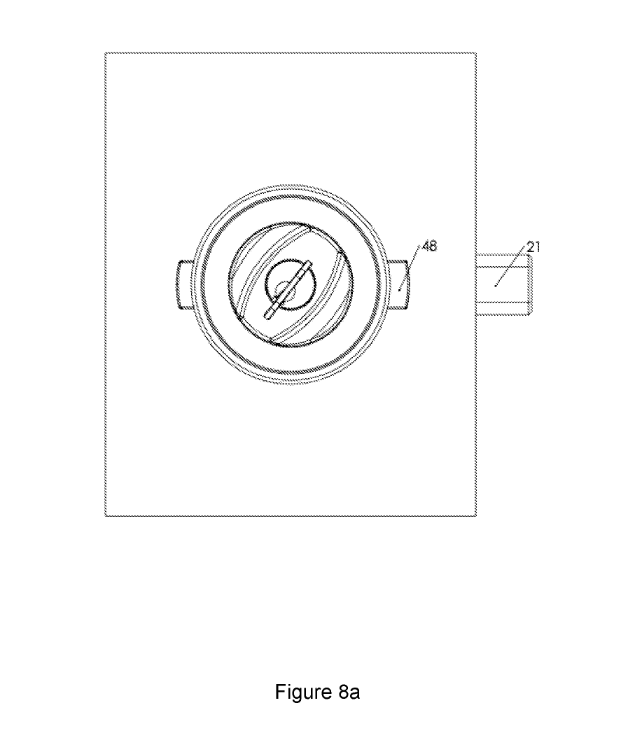

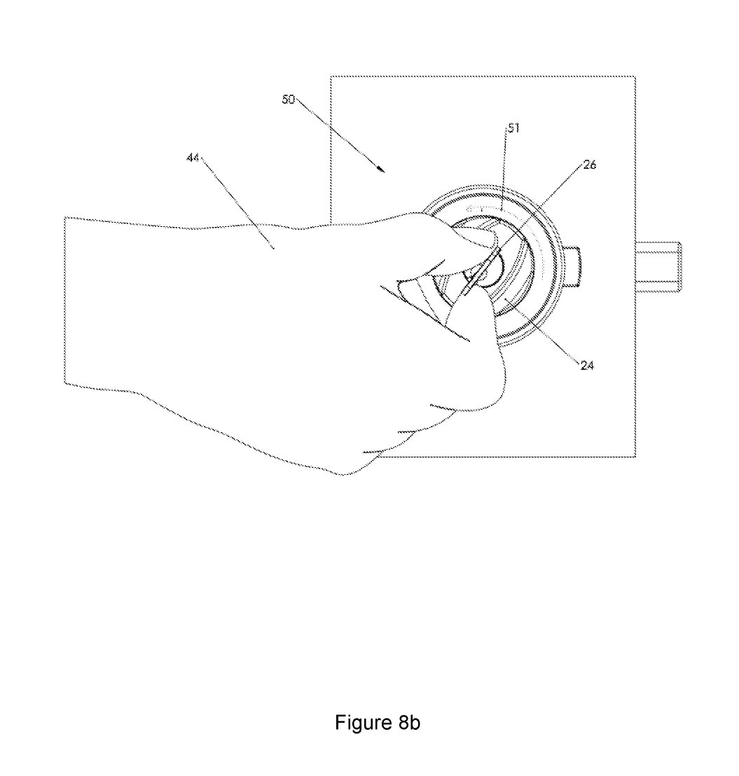

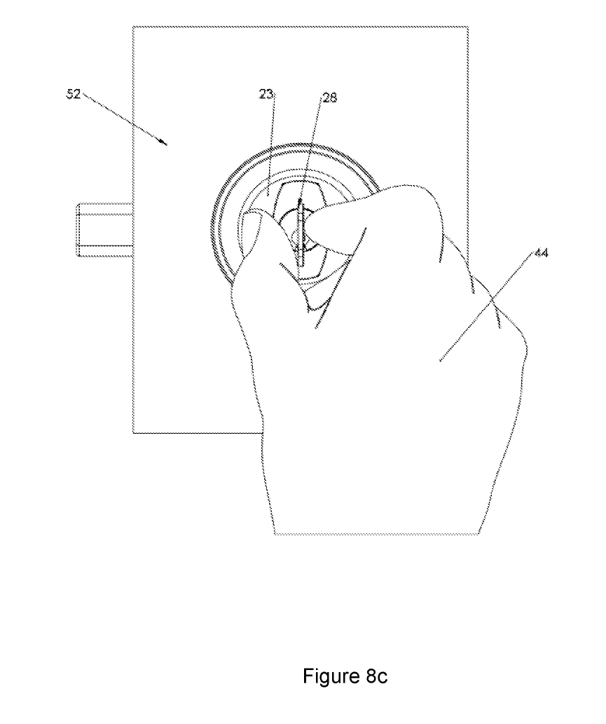

FIGS. 8a to 8c show schematically and generally by way of inside operation (50) (FIG. 8b) and outside (52) (FIG. 8c) operation as to how the locked status can be changed to the deadbolt lock unlocked position.

Internally the user must insert the key (26) so as to be able to rotate the knob (24) shown by way of arrow (51) by the operation of the user's hand (44).

Alternatively as seen from the outside scenario (52) the user's hand (44) would utilise the authorised key (28) and rotate the key (28) accordingly.

Therefore for security purposes the requirement of the use of a key both internally and externally prevents any unwanted unlocking of the door by someone who has entered the building illegally and wishes to exit from the door that has been previously and deliberately placed in the deadbolt lock locked position.

The act of the user placing the deadbolt lock in the locked position is deliberate because, as introduced throughout FIGS. 2 to 9, the requirement to permit the lock from going to the deadbolt lock locked position is done initially only by the deliberate action of a user engaging the deadlock control tab (32) and sliding, pushing or pressing the tab back within the internal housing block (18).

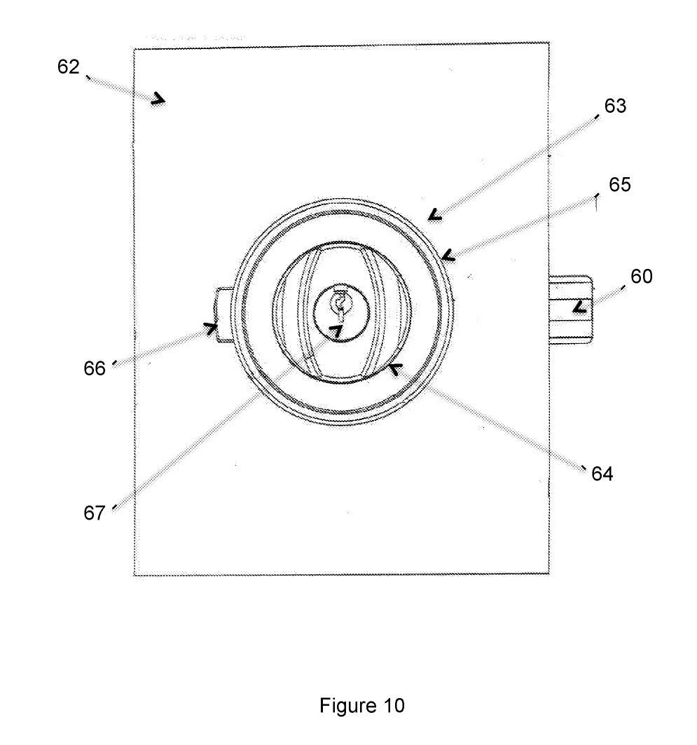

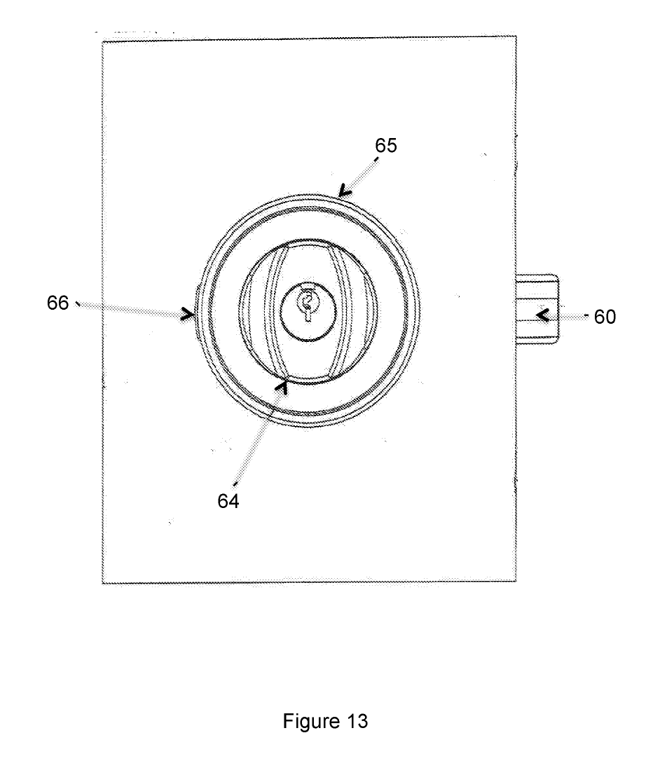

FIGS. 10 to 14 for the most part are consistent with the operation shown for the double cylinder deadbolt lock arrangement, however in this preferred embodiment illustrated in FIGS. 10 through to 14 there is the use of a self-latching bolt or latch (60) wherein the latch (60) does not have to be deliberately thrown as the bolt (21) would be as part of the bolt assembly (20) in the preferred embodiment shown in FIGS. 1 to 9. The latch (60) is self-latching with a strike (not shown) within the frame (not shown) supporting the door, which in FIG. 10 in the preferred embodiment shows the internal side thereof such a door as (62).

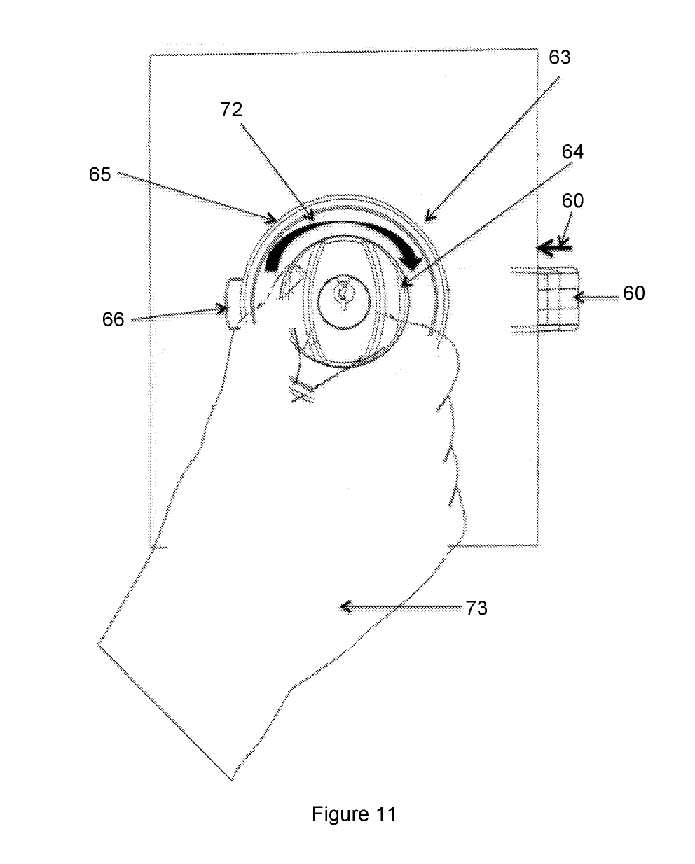

The internal housing block (63) of the deadlatch lock arrangement is shown throughout FIGS. 10 to 14 and with the previous preferred embodiment discussed in connection with FIGS. 1 to 9 includes the same kind of user rotatable knob (64) which will be able to, as best seen in FIG. 11, extend and retract the latch (60) shown by way of corresponding arrows (72) and dashed line imagery of the relative movement of the latch (60) between an extended and a retracted position within the edge of the door all possible while the deadlock control tab (66) remains extended out from the peripheral edge (65) of the internal housing block (63).

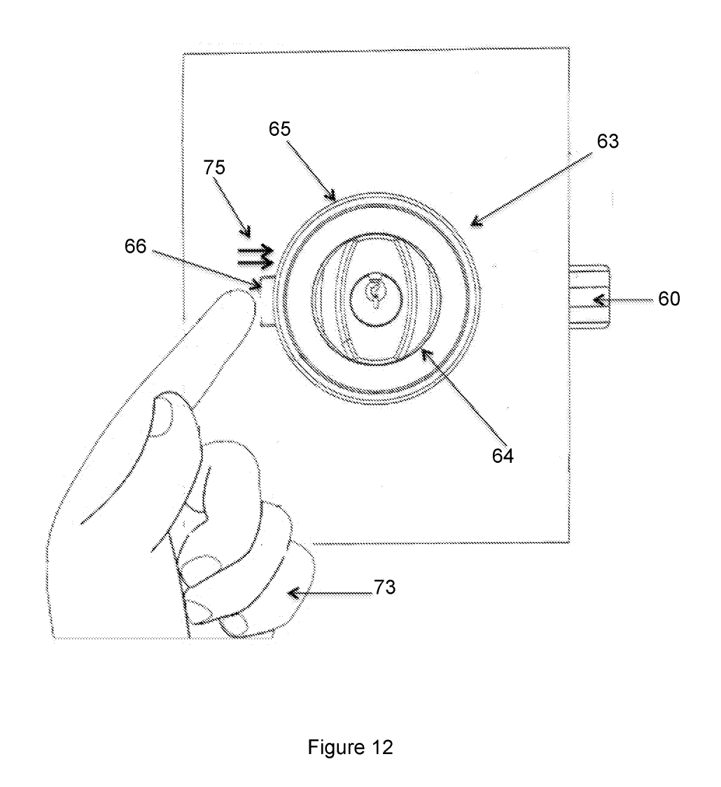

As best seen in FIG. 12, if the deadlatch lock is required to be placed in the deadlatch lock locked position there is the requirement first of the user, shown by way of the hand (73) engaging the deadlock control tab (66) extending out from the periphery (65) of the internal housing block (63) to press or push the tab (66) back inside the internal housing block (63) as shown by way of arrows (75).

Once the deadlatch lock has been primed by way of the deadlock control tab (66) being inserted back inside the internal housing block (63) the deadlatch lock can be placed in the locked position by way of the internal engagement (not shown) of a user by rotating a knob (not shown) of the internal housing block (not shown) or alternatively by an external scenario user engagement wherein the user uses an authorised key (not shown) to appropriately engage the external key cylinder (not shown) in the external housing block (not shown) where upon rotation would be allowed to place the deadlatch lock in the deadlatch lock locked position.

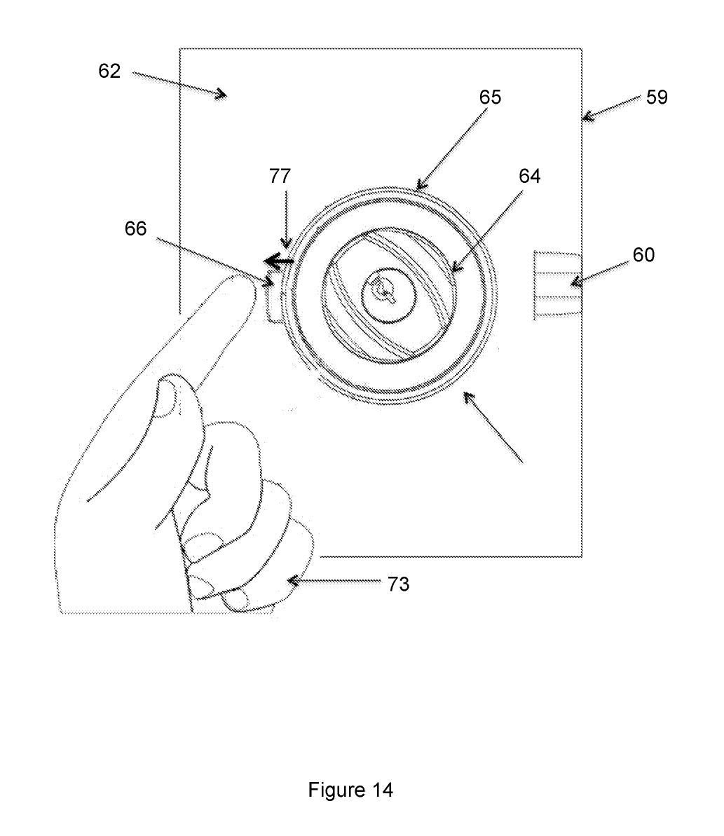

FIG. 14 shows illustratively how the user's hand (73) will be prevented from pushing in the deadlock control tab (66) shown by way of arrow (77) as the latch (60) is in the retracted position inside the edge (59) of the door.

Referring to the drawings now in greater detail where a double cylinder deadbolt lock arrangement is shown generally as (110) and includes three main parts or pieces, notably the internal housing block (112), the bolt assembly or bolt block (114) and external housing block (116).

As the illustration depicts, there is no additional unattached componentry of the deadbolt lock that needs to be incorporated for the deadbolt to become operational.

An installer is able to take the three parts of the double cylinder deadbolt lock and install them conveniently onto the door, wherein the double cylinder deadbolt lock becomes operational once mounted.

To mount the double cylinder deadbolt lock all that is required is for the door to have the defined main bore hole at the level where the lock will be mounted.

There will also be the requirement of the cross-bore starting from the edge of the doorframe so that the bolt assembly (114) can be recessed and bolted onto the edge or depth of the doorframe through the bolt assembly (114) plate (113).

With the bolt assembly (114) mounted, the internal housing block (112) through the tab extensions (128) and (130) can then be conveniently aligned and located about the bolt assembly (114) to then be mounted to the door.

As will be explained in greater detail shortly hereafter, with the internal housing block mounted to the internal side of the door, fixing screws can then engage the corresponding external housing block so that the external housing block can then be securely mounted to the external surface of the door to complete the double cylinder deadbolt lock installation.

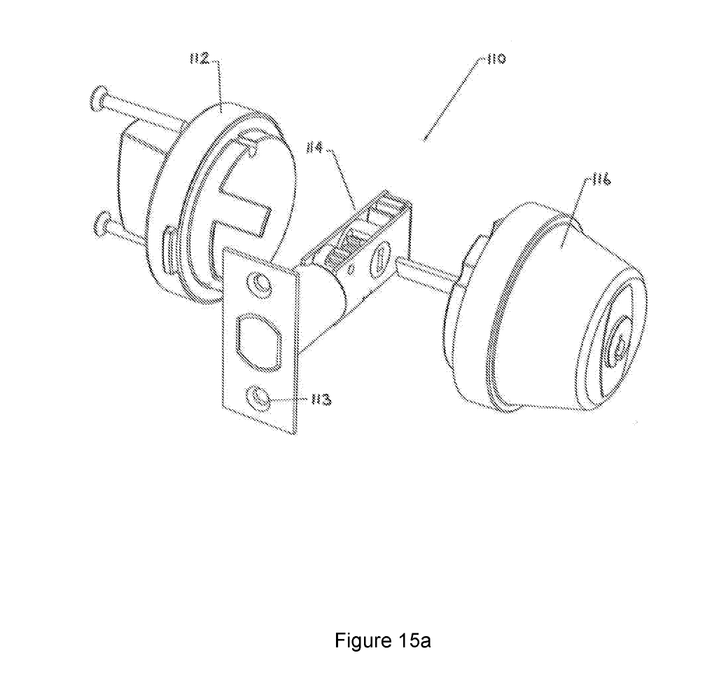

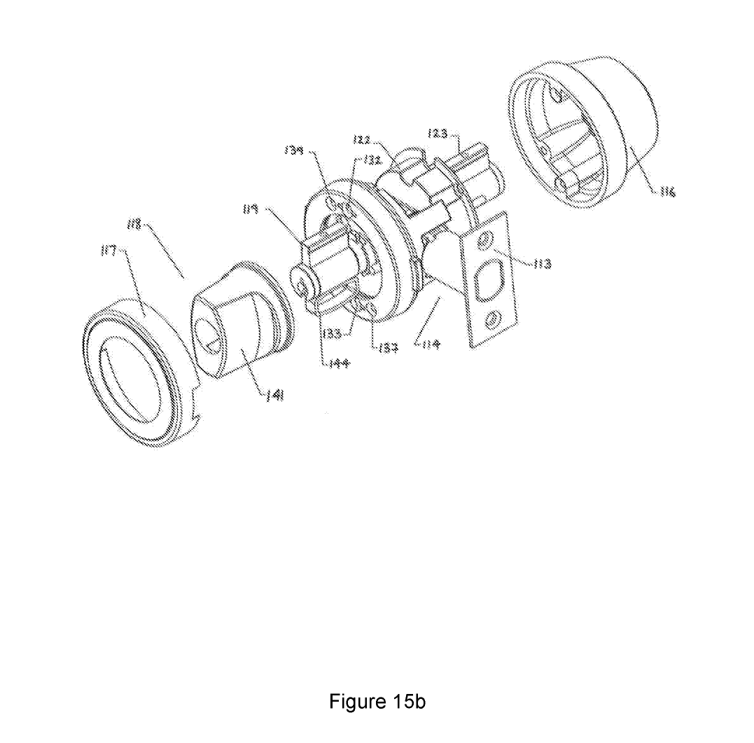

FIG. 15b shows a part exploded view of the internal housing block (112), bolt assembly (114) and external housing block (116) so as to appreciate how these parts also include sub-assemblies.

Referring to FIGS. 15b, 16, 17, 18a, 18b, 19 and 20 the internal housing block includes a sub-assembly arrangement of an internal key cylinder housing enclosure (118) which has an external profile adapted for a user's thumbs rotatability (141).

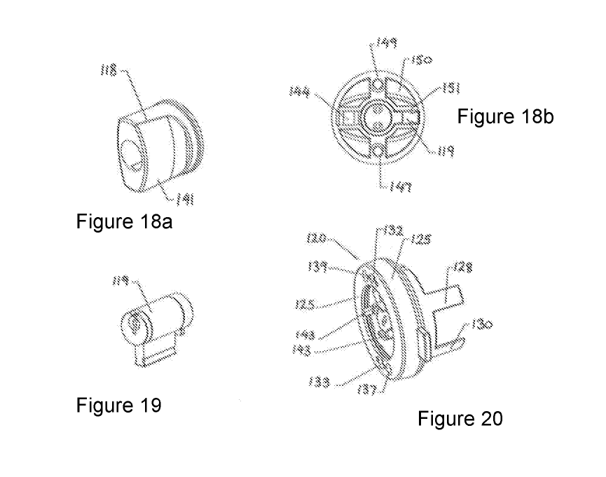

Importantly the internal cylinder housing enclosure (118) as best seen in FIG. 18b also has an internal profile generally shown as (150) which includes guide support (151) which will allow the internal key cylinder (119) to rest therein.

There is also a resilient block (144) which assists in providing resiliency but also an interference stabilising fit of the internal key cylinder (119) within the profiled guide supports (151) within the internal spacing (150) of the internal key cylinder housing enclosure (118).

Keyhole (134) allows the key access (135) of the internal key cylinder (119) to protrude thereout from said hole (134).

Also as seen in FIG. 18b slots (147) and (149) have been profiled into the internal spacing (150) of the internal key cylinder housing enclosure (118) so it can be attached to the other sub-assembly arrangement part, that being the main internal housing body (120).

When access to the internal key cylinder (119) is required, all that is required is for the internal cylinder housing enclosure (118) to be separated from the main internal housing body (120).

As the internal key cylinder (119) operably engages the locking mechanism through its rotatable support on guides (143) when the internal key cylinder (119) is withdrawn there is no interruption to the locking mechanism components incorporated as part of the main internal housing body (120) sub-assembly arrangement of the internal housing block (112).

The main internal housing body (120) includes a lower section (127) with a generally circular shape and dimensions and of a depth so as to be able to comfortably rest with the defined bore hole to which the internal housing block (112) will partially rest there within.

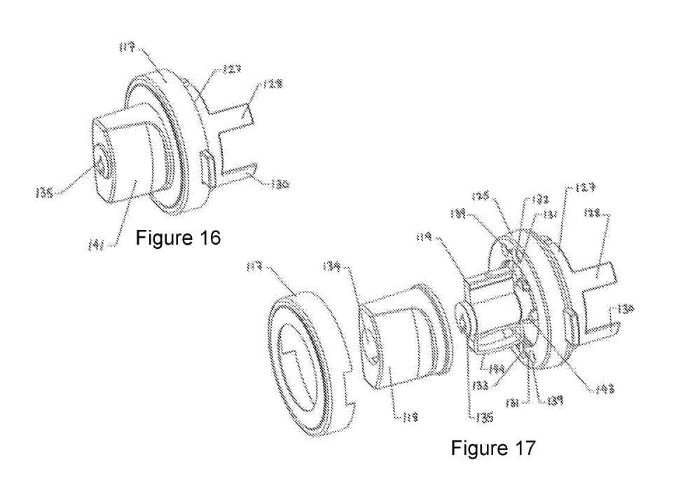

The pair of tab extensions (128) and (130) as best seen in FIG. 16 help to locate and align the internal housing block (112) with respect to the bolt assembly (114).

As best seen in FIG. 15b holes (137) and (139) which pass through the circular raised collar or rim (125) of the upper section of the main internal housing body (120) to fix the internal housing block (112) to the internal side of the door.

Through holes (132) and (133) which include special markings (131) provide information to the installer that these holes (132) and (133) are the main through holes which will pass through the internal housing block (112) so as to engage corresponding slots in the external key cylinder housing (111) which will be discussed in greater detail, will ultimately allow the external housing block (116) to be mounted to the external side of the door.

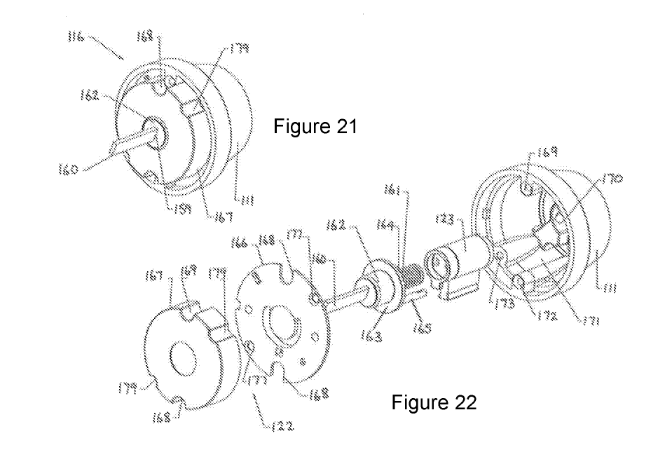

FIG. 15b in part, FIGS. 21, 22, 23, 24 and 25 show the external housing block (116) and the sub-assembly arrangement parts of the external key cylinder housing enclosure (111) and the main external housing body shown generally as (122).

The main external housing body (122) has a rounded raised block (167) with a separate base plate (166). The base plate (166) includes along its periphery circular edge slots (168) and holes (177) that match the corresponding grooves (169) and (179) within the peripheral profile along the circumferential edge of the rounded raised block (167) allowing for the respective mounting and fixing screws to pass there through.

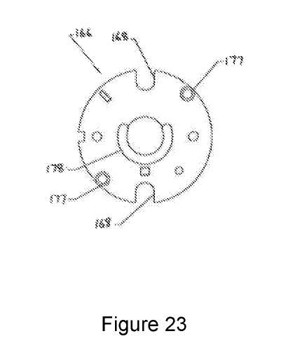

Importantly the main external housing body (122) within the raised rounded block (167) houses a spindle (160) under a spring bias (161), wherein the spindle is contained within guide barrel (162), which has a slot (159) that allows the spindle (160) to pass there through. The spindle (160) and the barrel (162) is supported upon raised platform (163) by way of leg extensions (164) and (165) wherein rotation of the external key cylinder lock (123) rotatable supported on guides (178) as best seen in FIG. 23 will see the rotatable movement of the spindle (160).

Accordingly the spring biased spindle not only has the ability to rotate about its lateral axis it also has the ability to be pushed in and out thereby the extended length of the spindle (160) can be varied depending upon the depth of the door to which the deadbolt lock arrangement is required to be mounted thereto.

As introduced above, rather than having to have the installer either cut the spindle (160) and/or interrupt the locking mechanism in order to put in place a spindle of appropriate length to fit the door of a particular depth, all these problems are overcome as uniquely the main external housing body sub-assembly arrangement of the external housing block (116) structures itself to support and maintain therein a spring bias for spindle (160).

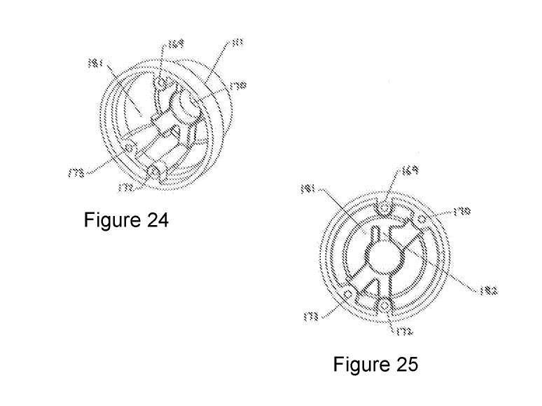

As best seen in FIGS. 24 and 25 the external cylinder housing enclosure (111) has an internal spacing (181) with a structured profile (182), which will allow the external key cylinder (123) to be operably retained therein within the profile guides (182).

As with the internal key cylinder (119), the external key cylinder (123) can be conveniently accessed simply by disengaging the main external housing body (122) from the external key cylinder housing enclosure (111).

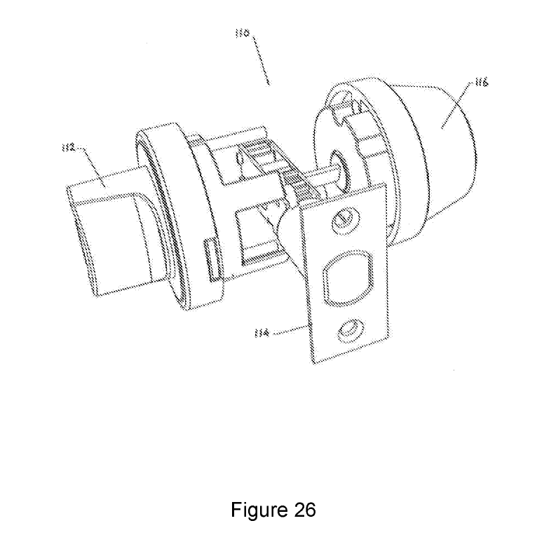

As introduced above, FIG. 26 for the most part is a similar representation to that shown in FIG. 15a, however the internal housing block (112), bolt assembly (114) and external housing block (116) are shown closer together.

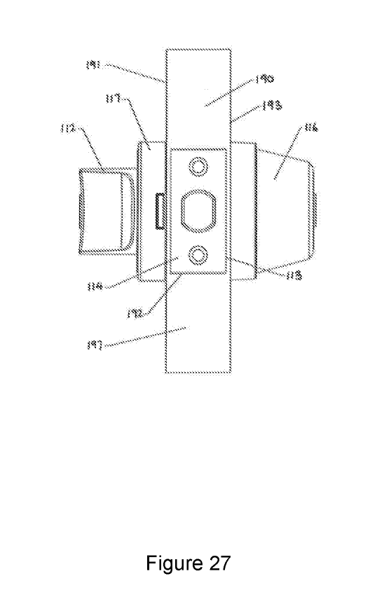

In FIG. 27 it shows the double cylinder deadbolt lock arrangement (110) mounted to a door (190) wherein the internal housing block is mounted to the internal side (191) of the door (190).

Collar (117) is also included as part of the internal housing block (112) as it provides an aesthetic appearance to cover up the fastening screws that show on the sub-assembly arrangement of the main internal housing body (120).

The bolt assembly is positioned on the edge or depth of the door within a set recess (192) and as discussed previously the mounting arrangement sees the external housing block securely fixed up against the external side or surface (193) of the door (190).

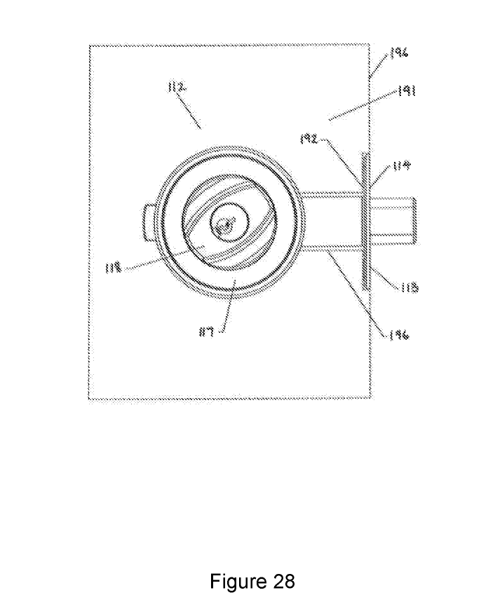

FIG. 28 shows the internal housing block (112) mounted to the internal side (191) of the door (190) with the bolt assembly (114) through the mounting plate (113) mounted within the cross-bore hole (196) from the edge or depth (197) of the door (190).

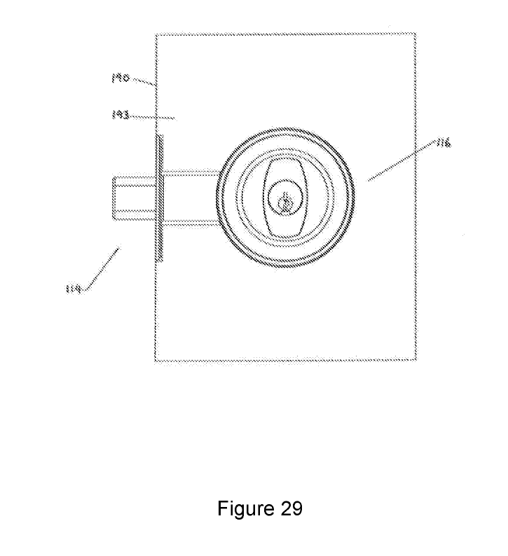

FIG. 29 shows the external housing block (116) secured in place about the external face or side (193) of the door (190) relative to the bolt assembly (114).

As introduced above, this invention relates to a deadbolt locking assembly and an operation thereof for a double cylinder deadlock arrangement rather than a double cylinder deadbolt lock arrangement per se.

The point to be made is that the deadbolt locking assembly and the operation thereof to be described in this preferred embodiment can be utilised in other double cylinder deadbolt lock arrangements providing the requisite essential features of this deadbolt locking assembly are included.

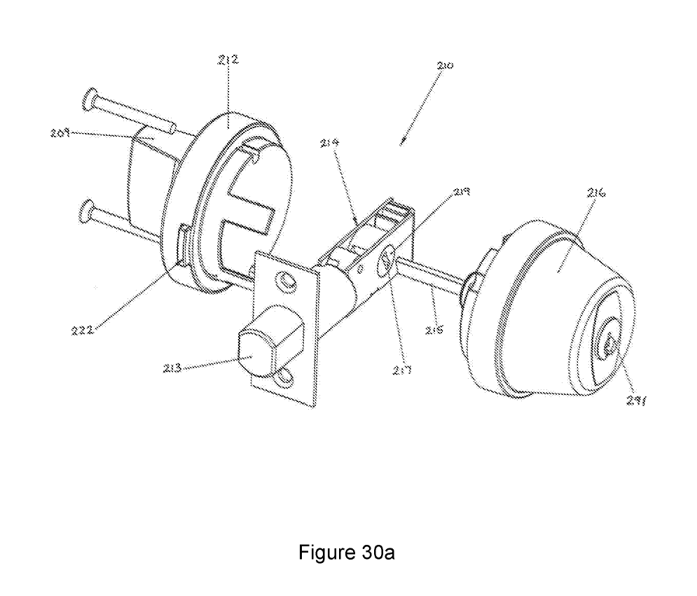

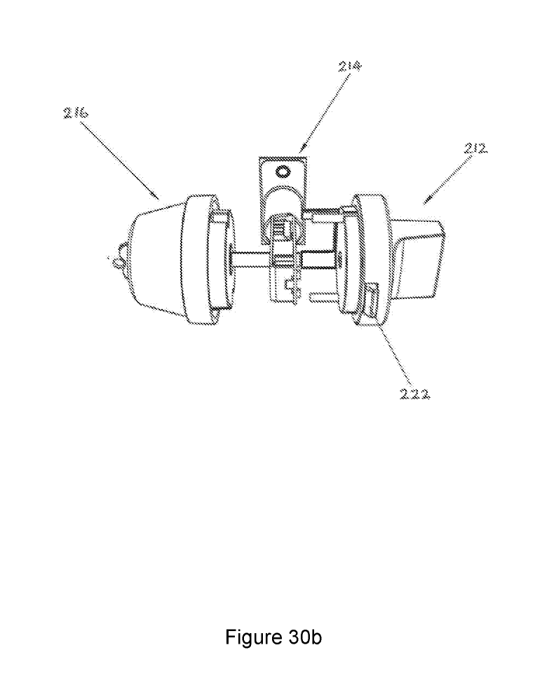

In order to place the deadbolt locking assembly in context with its use within a double cylinder deadbolt lock arrangement, FIGS. 30a and 30b are provided.

In the double cylinder deadbolt lock arrangement (210) there is included three main parts or pieces, notably the internal housing block (212), the bolt assembly or bolt block (214) and external housing (216).

In the double cylinder deadbolt arrangement (210) shown in FIGS. 30a and 30b, while not shown, key cylinders incorporated in both the internal housing block and external housing block for the most part either directly or indirectly provide for rotational operation of the spindle (215) which is received within the slot (217) of a drive cam (219) which is able to extend and retract the bolt (213) from the bolt assembly (214) as required in order to place the double cylinder deadbolt lock arrangement (210) in the deadbolt locked or unlocked position.

This invention focuses on the controlled operational way in which that spindle (215) will be permitted to be rotated dependent upon the deadbolt locking assembly which will be enclosed within the internal housing block (212) in this preferred embodiment of the invention.

Notably shown in FIGS. 30a and 30b is an essential aspect of the deadbolt locking assembly of this invention, that being the segment of the user operable deadlock control trigger tab (222) which is extendable out from the peripheral edge of the internal housing block (212) for user operable engagement.

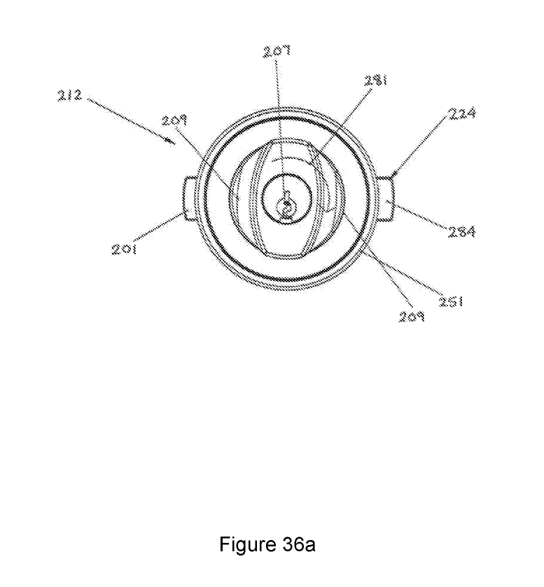

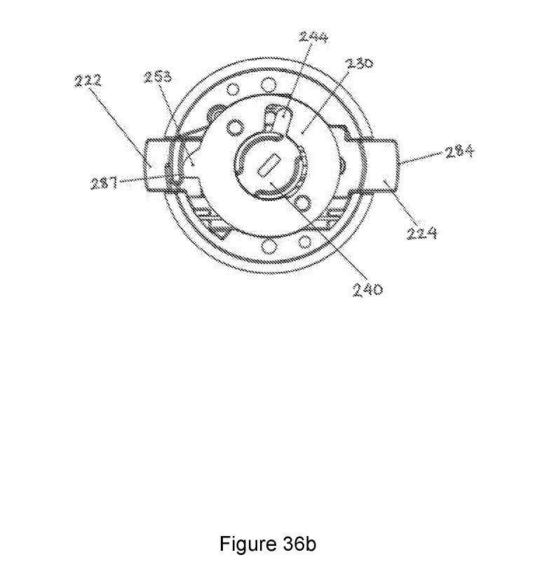

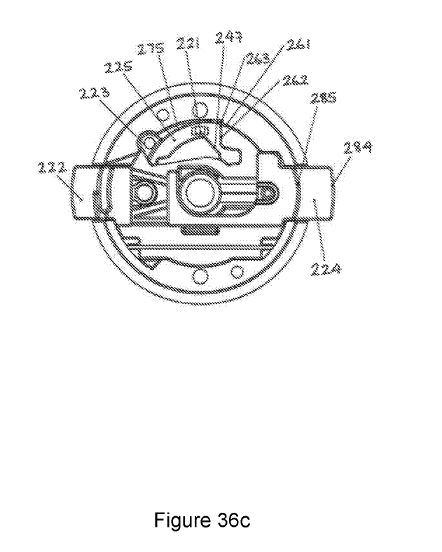

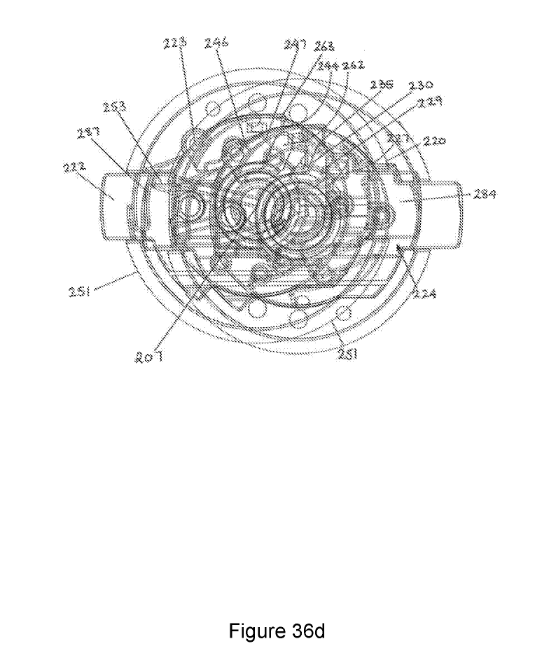

As will be explained in greater detail shortly hereafter, when the user pushes the deadlock control trigger tab (222) into the internal housing block (212) or as illustrated in greater detail within the lower housing block (220) enclosed within the internal housing block (212) this then primes the double cylinder deadlock arrangement (210) which will then permit a user by way of inserting a key into the external housing block (216) or by rotating the knob (209) of the internal housing block (212) so as to provide for a configuration that has the deadbolt locking assembly in the locked position as illustrated in FIGS. 36a, 36b, 36c and 36d.

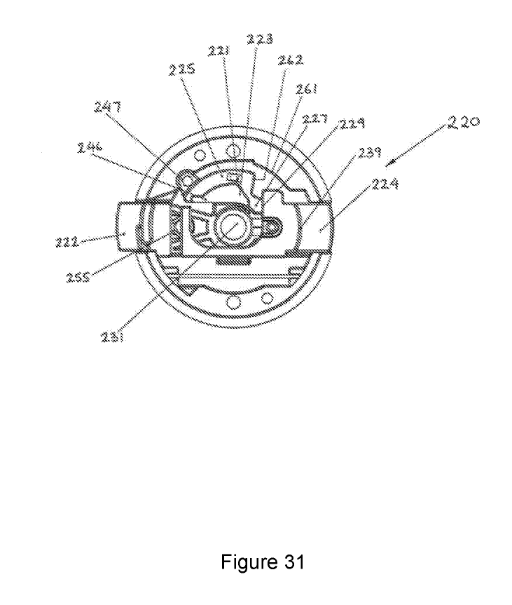

FIG. 31 shows the lower housing block generally as (220) which slidably supports the deadlock control trigger tab (222), which is adapted to laterally engage the deadlock activation tab (224).

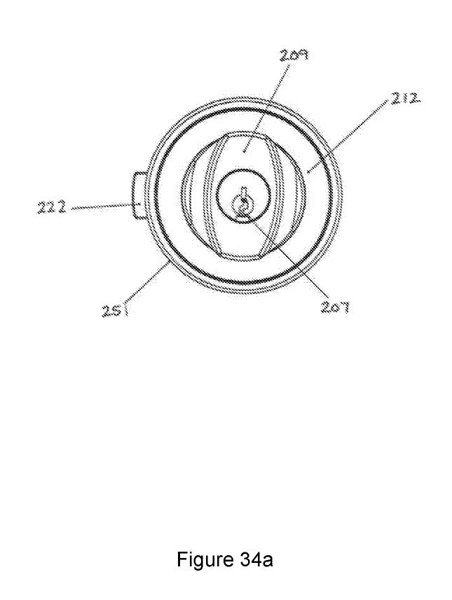

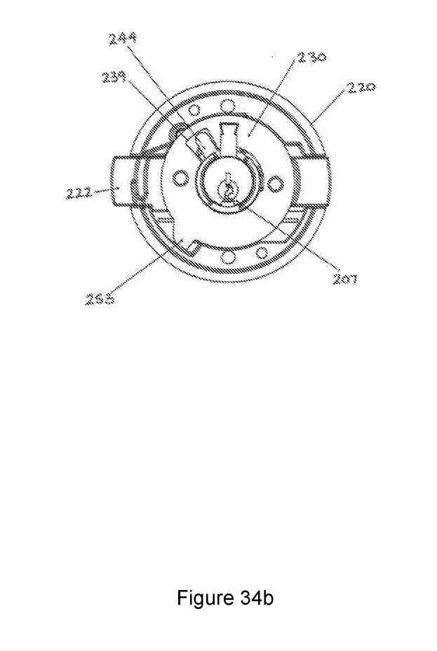

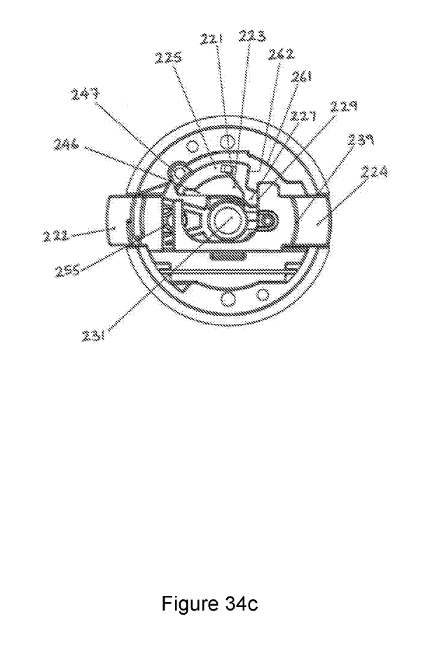

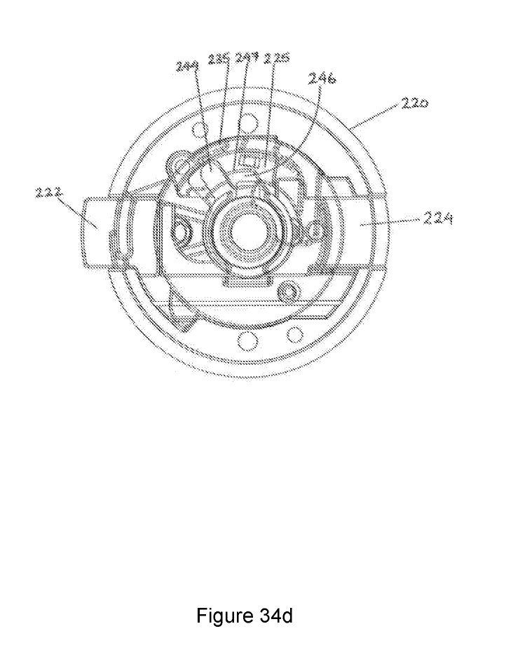

FIG. 31 for the most part is the same representation provided for in FIG. 34c when the deadbolt locking assembly is in the deadbolt unlocked position and is not primed, activated or triggered to be able to be placed into the deadbolt locked position.

The deadbolt holding arm (225) is biased through spring (221) and is pivotally supported at one end (223) to the lower housing block (220).

At the other end of the deadbolt holding arm (225) is a distal notch extension (227) which is receivable into a receival slot when the deadbolt holding arm (225) is in the captured position as illustrated in FIGS. in 31 and 34c.

The operational aspect of the workings of the deadlock control trigger tab (222), deadlock activation tab (224) and the deadbolt holding arm (225) will be discussed in greater detail when referencing FIGS. 34a, 34b, 34c and 34d.

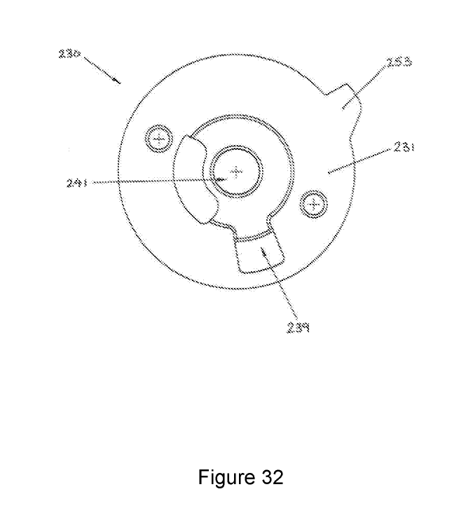

FIG. 32 shows the upper side (231) of the upper housing block (230), which is able to rotatable engage through the slot (231) defined by the lower housing block (220) and the cylindrical column (232) extending from the underside (233) of the upper housing block (230).

The relevance of which will be discussed in greater detail when referencing the series of figures in 34, 35 and 36, the upper housing body (230) on the underside also includes a lug extension (235), a guide track (237), which is adapted to engage the raised knob or section (239) extending out from the deadbolt activation tab (224).

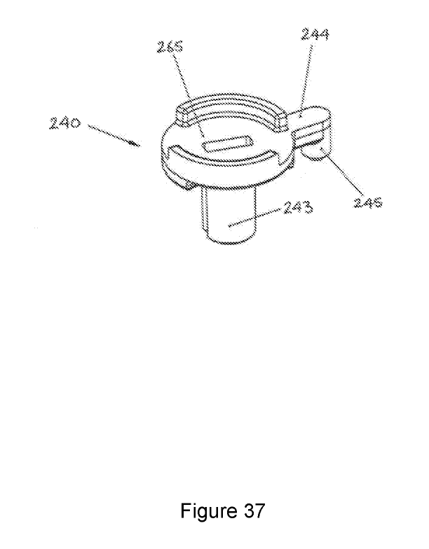

The upper housing body (230) also includes a slot (239) and a slot (241) which is the internal confines of the column (232) extending out from the underside (233) of the upper housing body (230), wherein the deadbolt release cam shown generally as (240) in FIG. 37 is rotatable rested and supported therein by virtue of shaft (243) of the deadbolt release cam (240).

The deadbolt release cam (240) includes the finger extension (244) which is able to be guided within slot (239) of the upper housing body (230) and wherein the stem (245) is able to interconnect with the raised shoulder (246) along the edge (247) thereof to be able to bias the deadbolt holding arm (225) back into the captured configuration within the deadbolt activation tab which will be discussed in greater detail shortly hereafter.

Referring now to FIGS. 34a, 34b, 34c and 34d wherein the deadbolt locking assembly parts are configured so that the double cylinder deadbolt locking arrangement (210) remains in a deadbolt unlocked position with the user operable deadlock control trigger tab (222) extended out from the periphery (251) of the double cylinder deadbolt lock arrangement (210) so it remains engaging and operable by the user.

FIG. 34a also assists in viewing the rotatable user knob (209), which as will be discussed in greater detail when referencing FIGS. 36a, 36b, 36c and 36d, is rotatable in a clockwise direction with or without a key to place the deadbolt in a locked position once the double cylinder deadbolt locking arrangement has been triggered.

As best seen in FIG. 34c the deadlock control trigger tab (222) is slidably supported upon the lower housing block (220) resiliently by way of spring (255).

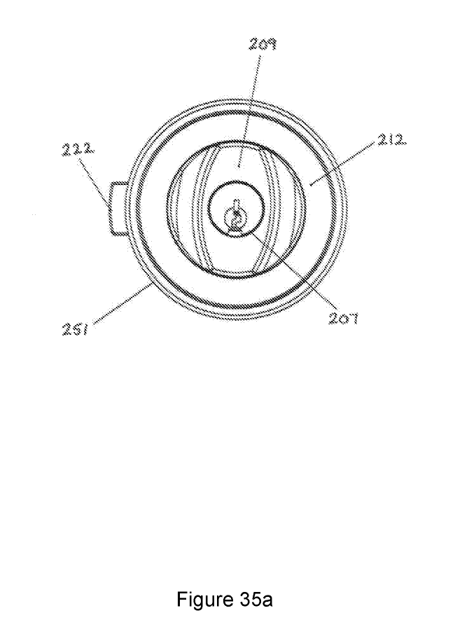

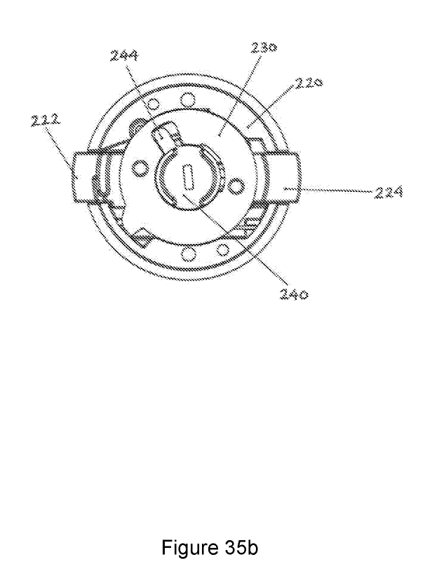

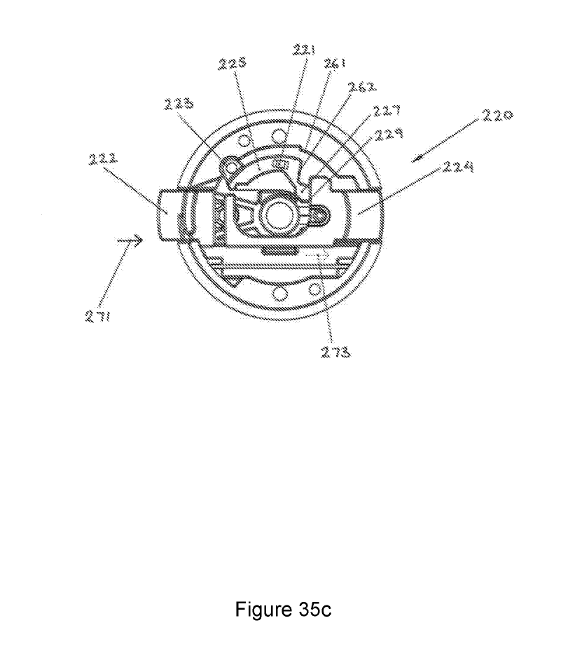

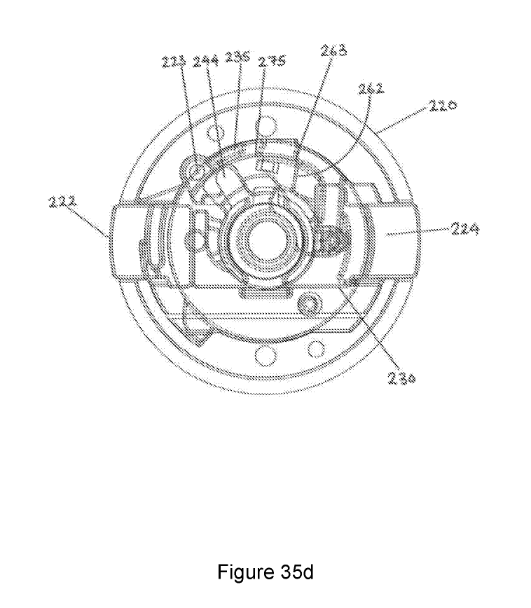

As will be discussed in greater detail when referencing FIGS. 35a, 35b, 35c and 35d the deadlock control trigger tab (222) is laterally aligned so that once it is inserted into the peripheral confines of the lower housing block (220) it is able to slidably engage with the deadlock activation tab or slide (224).

While the deadlock control trigger tab (222) remains in the untriggered configuration as seen in FIG. 34c, the deadlock activation tab (224) is able to capture and contain the notch extension (227) of the deadbolt holding arm (225) within the receival slot (229) of the deadlock activation tab (224).

With the deadbolt holding arm (225) captured within the receival slot (229) of the deadlock activation tab the deadbolt holding arm (225) is biased away from a configuration that would allow for the deadbolt locking assembly to provide for a deadbolt locked position or configuration.

Any relative rotation between the lower housing body (220) with the upper housing body (230) will not result in any deadbolt lock positioning as which will be as the lug extension (235) extending from the underside (233) of the upper housing block doesn't engage and is not prevented from an anti-clockwise direction rotation which would not have been possible when the deadbolt holding arm (225) has been freed from its capturing within the receival slot (29) of the deadbolt activation tab (224) as shown in FIGS. 36a, 36b, 36c and 36d.

Viewing FIG. 37 of the deadbolt release cam (240) and FIG. 34b it is to be understood that the spindle (215) is able to pass there through the shaft (243) and into the receiving slot (265) of the deadbolt release cam (240).

As introduced above, the deadbolt release cam (240) is slidably rotating within the upper housing body (230) and as the finger (244) and stem (245) are restricted within slot (239) so as to remain interconnected to the defined edge (247) of the raised shouldered portion (246) of the deadbolt holding arm (225) means that if the upper housing body (230) is restricted from rotating by virtue of the lug (235) engaging an uncaptured deadbolt housing arm (225) frontal edge (262) this would then translate to restrictive movement of the deadbolt releasable cam (240) which would stop any rotational movement of the spindle (215), thereby preventing movement of the bolt.

The opposite scenario is also the case in that so long as the upper housing body (230) is able to freely rotate this will then also allow the deadbolt release cam (240) to be able to rotate thereby preventing the spindle (215) which engages the bolt assembly (214) drivable cam (219) through the slot (217) from being fixed within a deadbolt locked position.

The only way in which the deadbolt locking assembly of this invention can be activated so as to be able to place the double cylinder deadbolt lock arrangement in the deadbolt locked position is by a user pushing the user operable deadlock control trigger tab (222) into the lower housing body (220) so as to slidably engage the deadlock activation tab or slide (224).

As best seen in FIGS. 35a, 35b, 35c and 35d the actual locked status of the double cylinder deadbolt deadlock arrangement (210) remains unchanged from the unlocked status shown in FIGS. 34a, 34b, 34c and 34d but what is different is that the deadbolt locking assembly by virtue of the user having slidably inserted the deadlock control trigger tab (222) into the lower housing body (220) has been able to activate or prime the deadbolt locking assembly so that the double cylinder deadbolt lock arrangement (210) can now be placed in the deadbolt locked position if so desired by the user.

Accordingly the double cylinder deadbolt lock arrangement (210) cannot be inadvertently or accidentally placed in the deadbolt locked position unless a conscious decision is made to insert the deadlock control trigger tab (222) from its external extension out from the peripheral edge (251) of the internal housing block (212) to be inserted into the lower housing block (220) of the deadbolt locking assembly as best seen in FIGS. 35b and 35c.

In FIG. 35c the arrow (271) signifies the lateral slidable movement of the user operable deadlock control trigger tab (222), which then slidably engages, shown by way of arrow (273), to laterally push across the deadbolt activation tab (224).

This slight lateral movement of the deadbolt activation tab (224) releases the notch (227) of the deadbolt holding arm (225) from being captured within the receivable slot (229) of the deadbolt activation tab (224).

As the deadbolt activation arm (225) is biased by the spring (221), once the notch (227) is released from being captured within the receivable slot (229) of the deadbolt activation tab (224) it is able to spring away from the deadbolt activation tab (224).

The deadbolt activation arm (225) presents the front abutting edge (262), the relevance of which will be discussed in greater detail when referencing FIGS. 36a, 36b, 36c and 36d but from FIGS. 35a, 35b and 35c it can be realized that the lug (235) extension still remains of the first side of the deadbolt activation arm (225) and has yet to be rotated to the second side past the apex (263) along the edge (247) of the raised shoulder (246) of the deadbolt activation arm (225). Hence the assembly still remains deadbolt unlocked, albeit the ability to deadbolt lock the assembly becomes possible as the deadbolt activation arm (225) has been released from its captured position.

As the deadbolt locking assembly is in the primed position this means that it is possible to rotate the upper housing body (230) relative to the lower housing body (220) in a clockwise direction as best seen in FIG. 35d the lug extension (235) on the underside (233) of the upper housing body (230) still remains on the left-hand side or a first side of the apex (263) which commences thereafter the abutting frontal edge (262) of the deadbolt holding arm (225).

As the deadbolt holding arm (225) is pivotally supported (223) and biased by spring (221) rotation of the upper housing body (230) will allow the lug extension (235) to be rotated in a clockwise direction where through the biasing of spring (221) forms the upper shouldered edge (275) of the deadbolt holding arm (225) to be pressed down to avoid the apex (263) from being fixed in place up against the internal skirt (261) of the lower housing body (220).

As will be described in greater detail when referencing FIGS. 36a, 36b, 36c and 36d, once the lug (235) has been rotated beyond the apex (263) of the deadbolt holding arm (265) the apex (263) will then be able to be biased up for the abutting engagement with the internal rim or skirt (261) of the lower housing body (220) thereby preventing any subsequent rotation back of the upper housing body in an anti-clockwise direction while that apex (263) of the deadbolt holding arm (225) remains abutted up against the internal collar or skirt (261) of the lower housing body (220).

If the upper housing body (230) is prevented from rotation that means the deadbolt release cam (240) rotatable supported therein the upper housing body (230) is also preventing from moving and so too then the spindle (215) which is engaging the driveable cam (219) through the slot (217) of the bolt assembly (214).

FIGS. 36a, 36b, 36c and 36d illustrate the deadbolt locking assembly in the deadbolt locked position.

Arrow (281) in FIG. 36a represents rotation of the knob (209) in a clockwise direction.

Rotation of the knob (209) in a clockwise direction translates to rotation of the upper housing body (230) from the configuration shown in FIGS. 35a, 35b, 35c and 35d to the one shown in 36a, 36b, 36c and 36d.

As introduced previously, rotation of the knob (209) and the upper housing body (230) which then translated to rotational clockwise movement of spindle (215) to place the bolt (213) of the bolt assembly (214) in an extended position was permitted as the deadbolt holding arm (225) had been released from being captured within the deadbolt activation tab (224) and the lug (235) extending out from the underside (233) of the upper housing body (230) as it rested on the upper shoulder (275) of the deadbolt housing arm (225) could force the deadbolt housing arm (225) down as it rotated there along the upper shoulder (275) so it could start from a first side relative to the apex (263) of the deadbolt housing arm to a second side relative to the apex (263) which is then able to bias up against the internal skirt or collar (261) of the lower housing body (220) as the lug (235) is now extended beyond the apex (263). The lug (235) is trapped from moving back in an anti-clockwise direction as the lug (235) abuts up against the frontal edge (262) of the deadbolt housing arm (225).

Accordingly, as the upper housing body (230) is restricted from anti-clockwise direction, the rotatable deadbolt release cam (240) is also prevented from moving in an anti-clockwise direction while the apex (263) of the deadbolt holding arm (225) remains abutting up against the inner skirt or rim (261) of the lower housing body (220).

Accordingly, the bolt (213) extending out from the bolt assembly (214) remains in the deadbolt locked position.

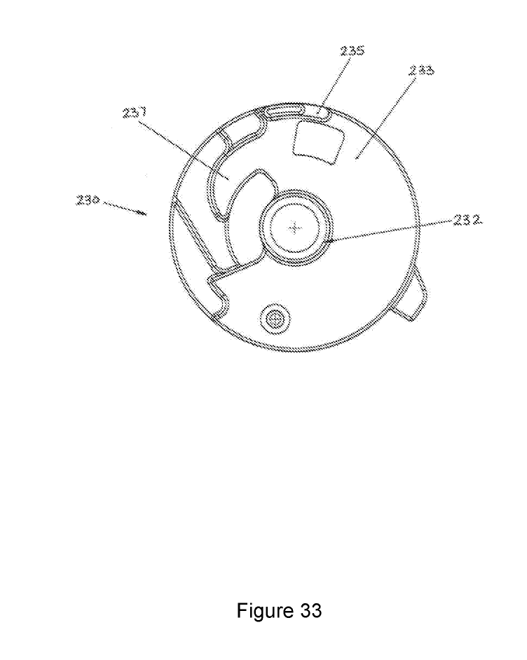

As the upper housing body (230) was rotated in the clockwise direction shown by way of arrow (281) the underside profile as best seen in FIG. 33 included the guide edge or track (237) which was able to engage the raised knob (229) so as to extend a segment (284) of deadlock activation tab (224) out beyond the peripheral edge (251) of the internal housing block (212) wherein this tab extension (284) acts as a visual and tactile indicator that the double cylinder deadbolt lock arrangement (210) is now in the deadbolt locked position.

The upper housing body (230) also includes along its circumferential edge a ram extension (253) which is able to engage the raised knob or length (257) of the deadlock control trigger tab (222) so as to extend the deadlock control trigger tab (222) out once again from the peripheral edge (251) of both the lower housing block (220) and the overall internal housing block (212).

In order to free the bolt (213) from the deadlock locked position a key is required to engage either the internal key cylinder (not shown) through the key-hole (207) of the internal housing block (212) or the external key cylinder (not shown) housed within the external housing block (216) through the external key-hold (291).

Authorised key entry into either key-hole (207) or (291) will rotate the corresponding internal or external key cylinders, which engages either the spindle (215) and/or the deadbolt release cam (240).

The rotation of the deadbolt release cam (240) or spindle (215) through the authorised key entry at (207) and (291) allows the stem extension (245) of the finger (244) extending from the deadbolt release cam (240) to interconnect with the deadbolt holding arm (225) along the edge (247).

As can be appreciated by viewing FIG. 36d if the finger (244) of the deadbolt releasable cam (240) is rotated in the anti-clockwise direction, as it engages the raised shoulder (246) along the profiled edge (247) of the deadbolt holding arm (225), due to the spring (221) the interconnection is allowed to push down the deadbolt holding arm (225) thereby removing the apex (263) of the deadbolt holding arm (225) away from its contact engagement with the inner rim or skirt (261) of the lower housing body (220) providing a gap which the lug (235) of the upper housing body (230) can rotatable pass there through rather than abutting up against the front edge (262) which was the case when the double cylinder deadbolt lock arrangement (210) was in the deadbolt locked position.

While not shown, the deadlock activation tab (224) is also spring biased and movement of the upper housing body (230) in the anti-clockwise direction causes the deadbolt activation tab (224) to spring back into its original lateral position once the notch (227) of the deadbolt holding arm (225) has been lowered down by the biasing interaction between the deadbolt release cam (240) finger (244) stem (245) interconnection and engagement with the raised shouldered (246) profiled edge (247) of the deadbolt holding arm (225).

As the upper housing body (230) is rotated away from a deadbolt locked position to a deadbolt unlocked position the ram tab (253) extending from the peripheral edge of the upper housing body (230) moves away from its abutting engagement with the raised knob or portion (287) extending out from the deadlock control trigger tab (222) thereby allowing the deadlock control trigger tab (222) to be in a re-set position ready to prime the deadbolt locking assembly for the double cylinder deadbolt lock arrangement (210) again as required.

1. A double cylinder deadlock lock arrangement, said arrangement including;
an internal housing block having an internal rotatable operable cylinder supported therein said internal housing block, wherein a controlled operable rotation of said internal rotatable operable cylinder provides for a deadlock lock unlocked position or a deadlock lock locked position when said arrangement is mounted to a door;
an external housing block with an external key cylinder supported therein said external housing block, wherein a controlled rotation of said external key cylinder when a key is receivable within a slot of said external key cylinder provides for a deadlock lock unlocked position or a deadlock lock unlocked position when said arrangement is mounted to the door; and
a deadlock control tab slidably supported within the internal housing block such that a segment of said deadlock control tab is extendible out from a peripheral edge of said internal housing block to allow for a user operable engagement with said deadlock control tab, wherein slidable retraction of the extended segment of said deadlock control tab by a user at least substantially into the internal housing block subsequently permits operable rotation of the internal rotatable operable cylinder and/or the external key cylinder when a key is received within the slot of the external key cylinder to move from a deadlock lock unlocked position to a deadlock lock locked position; and
a deadlock indicator tab slidably supported within the internal housing block such that when the internal rotatable operable cylinder and/or the external key cylinder have been permitted by virtue of the extended segment of the deadlock control tab being retracted substantially into the internal housing block and subsequent rotation to provide a deadlock lock locked position, said deadlock indicator tab is adapted to at least partially extend out from the peripheral edge of said internal housing block to provide a visual and tactile indicator that the arrangement is in the deadlock lock locked position.

2. (canceled)

3. The arrangement of claim 1 wherein the peripheral edge of said internal housing block to which the extended segment of the deadlock control tab is retractable there into and said deadlock indicator tab is partially extendible out therefrom, is substantially circular.

4. The arrangement of claim 3 wherein the deadlock control tab and the deadlock indicator tab are symmetrically arranged on opposing sides of said substantially circular peripheral edge of the internal housing block.

5. The arrangement of claim 4 wherein the deadlock control tab and the deadlock indicator tab are laterally or vertically arranged on opposing sides of the substantially circular peripheral edge of the internal housing block.

6. The arrangement of claim 1 wherein the controlled operable rotation of said internal rotatable operable cylinder from a deadlock lock unlocked position to a deadlock lock locked position is by a user rotation of an external knob with or without a key adapted to engage within a slot of the internal rotatable operable cylinder.

7. The arrangement of claim 6 wherein the controlled operable rotation of the internal rotatable operable cylinder between a deadlock lock locked position and a deadlock lock unlocked position includes an authorised key receivable within the slot of the internal rotatable operable cylinder.

8-30. (canceled)

31. The arrangement of claim 1 wherein the internal housing block includes a sub-assembly arrangement, said internal housing block sub-assembly arrangement including an internal cylinder housing enclosure having an external profile adapted for user rotation and said internal cylinder housing enclosure having an internal profile for operably retaining therein an internal key cylinder;
a main internal housing body wherein said internal cylinder housing enclosure is fastenable thereto, said main internal housing body characterised by enclosing a deadbolt lock locking arrangement and providing an external rotatable support for said internal key cylinder wherein when the internal cylinder housing enclosure is fastened to the main internal housing body, rotation of said internal key cylinder is adapted to in part control said deadbolt lock locking arrangement;
said main internal housing body further characterised by a pair of tab extensions, wherein a spacing between the pair of tab extensions allows the internal housing block to be locatable and in alignment about a bolt assembly when said internal housing block and bolt assembly are mounted upon a door.

32. The arrangement of claim 31 wherein the external housing block includes a sub-assembly arrangement including an external cylinder housing enclosure having an internal profile adapted to operably retain an external key cylinder, a main external housing body wherein said external cylinder housing enclosure is fastenable thereto, said main external housing body characterised with an external operable rotatable support of said external key cylinder, said external key cylinder in operable communication with a spring biased spindle, wherein said spring biased spindle is configured to pass through said bolt assembly and engage an external receivable slot of said main internal housing body when said external housing block is fixed thereto the internal housing block when said internal housing block is mounted to a door such that when said spring biased spindle is received within the external slot of said main internal housing body said spring biased spindle operably engages said deadbolt lock locking arrangement to control said bolt assembly; such that when the double cylinder deadlock lock arrangement is mounted to a door, the main internal housing body is fastened on an internal side of the door and partially within a first bore hole defined in the door with the pair of tab extensions located and positioned about the top and bottom of the bolt assembly, wherein said bolt assembly is fixed within a cross-bore hole from an edge of the door, and wherein the external housing block is fastened to an external side of the door and partially within the first bore hole supported by fixing screws supported by the main internal housing block when mounted to the internal side of the door such that the spring biased spindle is in operable engagement with the deadbolt lock locking arrangement to control said bolt assembly.

33. The arrangement of claim 32 wherein the sub-assembly arrangement of the main internal housing body includes a lower section with a peripheral collar to which said pair of tab extensions extend therefrom.

34. The arrangement of claim 33 wherein the lower section of the main internal housing body peripheral collar is of a depth so as to circumferentially engage within first bore hole defined in the door.

35. The arrangement of claim 34 wherein the external receivable slot of the main internal housing body includes a longitudinal rotatable slot of dimensions comparable to a distal end of the spring biased spindle.

36. The arrangement of claim 35 wherein the bolt assembly includes a rotatable bolt controller including a slot of comparable dimensions to the distal end of said spring biased spindle such that when the external housing block is fixable to the main internal housing block the spring biased spindle is adapted to pass through the slot of bolt controller in the bolt assembly to be received within the external receivable slot of the main internal housing body so as to operably engage the deadbolt lock locking arrangement.

37. The arrangement of claim 36 wherein the spring biased spindle is supported within the sub-assembly arrangement of the main external housing body by a raised rotatable platform.

38. The arrangement of claim 37 wherein the raised rotatable platform includes a pair of leg extensions which are adapted to rotate along the external operable rotatable support of the external key cylinder of the main external housing body such that rotation of the external key cylinder allows a rotation of the pair of leg extensions of the raised platform confining said spring biased spindle so as to translate said rotational movement to corresponding rotational movement of said spring biased spindle.

39. The arrangement of claim 38 wherein the main external housing body includes an upper section wherein the circumferential diameter of the upper section is such so as to allow the upper section to circumferentially rest within the first bore hole defined within the door.

40. The arrangement of claim 39 wherein a lower section of the main external housing body includes a separate circular base plate and a raised block.

41. The arrangement of claim 40 wherein the circular base plate includes a series of fastening holes which correspond to grooves longitudinally configured along the raised block and which also correspond to fastening holes of the external cylinder housing enclosure operably retaining the internal key cylinder such that the sub-assembly arrangement of the external housing block are fixable together.

42. The arrangement of claim 41 wherein a fixing of the external housing block to the main internal housing block includes two fastening screws or bolts positionable along definable pathways wherein said fastening screws or bolts include a flat resting head, restable upon the raised collar of the main internal housing body with the opposing terminal distal ends of said screws or bolts engaging corresponding slots defined within the external cylinder housing enclosure retaining the operable external key cylinder.

43. The arrangement of claim 42 wherein the holes to receive the fastening screws or bolts between the main internal housing block and external housing block include identifiable markers.

44. The arrangement of claim 43 wherein the main internal housing block further includes an external circular shouldered enclosing plate so that once the double cylinder deadbolt lock arrangement has been mounted to the door the raised collar with the fixed screws or bolts positioned therein can be covered thereby said external circular shouldered enclosing plate providing an improved aesthetic appearance.

45. The arrangement of claim 1 including a deadbolt locking assembly, wherein the deadbolt locking assembly includes:
a lower housing block adapted to slideably support a user operable deadlock control trigger tab, wherein a segment of the deadlock control trigger tab is extendible out from a peripheral edge of said lower housing block for user operable engagement when said assembly is in a deadbolt unlocked position when a double cylinder deadbolt lock arrangement is mounted to a door to be deadbolt locked;
a deadbolt holding arm pivotally supported within the lower housing block, said deadbolt holding arm biased between a captured position when said deadbolt holding arm is at least partially contained within a deadlock activation tab slideably supported within the lower housing block when said assembly is in a deadbolt unlocked position and an uncaptured biased position wherein the deadbolt holding arm is characterised in being biasable into an assembly deadbolt lock position or biased in the assembly deadbolt locked position;
an upper housing block adapted to be rotatably engageable with said lower housing block;
said upper housing block including an underside profile with a lug extension adapted to rotatably engage with said deadbolt holding arm, wherein rotation of said upper housing block in a first direction relative to the lower housing block enables the lug extension to become biasable in engagement with said deadbolt holding arm to be rotatable from a first position on one side of said deadbolt holding arm to a second side of said deadbolt holding arm, deadbolt holding arm further biased such that when the lug extension has been rotated to the second side of the deadbolt holding arm said assembly is in the deadbolt locked position;
a rotatable deadbolt lock release cam supported within the upper housing block wherein the rotatable deadbolt release cam includes a finger adapted to engage the deadbolt holding arm such that authorized rotation of the deadbolt release cam allows the finger to engage the deadbolt holding arm to bias said deadbolt holding arm into the captured position within the deadlock activation tab thereby allowing rotation of said upper housing block relative to the lower housing block in a second direction for the lug extension to return to the first side of the deadbolt holding arm thereby placing the assembly in a deadbolt unlocked position.

46. The arrangement of claim 45 wherein the deadlock activation tab slidably supported within the lower housing block includes a segment that is adapted to at least partially extend out from the peripheral edge of the lower housing block to provide a visual and tactile indicator that the deadbolt locking assembly for the double cylinder deadbolt lock arrangement has the deadbolt in a deadbolt locked position.

47. The arrangement of claim 46 wherein the upper housing block on an underside includes a track, guide or abutment profiled into the underside which is adapted to engage with a knob or raised section extending from the deadlock activation tab such that during relative rotation of the lower housing block with the upper housing block in the first direction so as to place the assembly in a deadbolt locked position, said knob or raised section engages the track, guide and/or abutment on the underside of the upper housing block so as to extend out the indicator segment of the deadlock activation tab to provide for the visual and tactile indicator externally to the double cylinder deadlock arrangement so a user is informed that the deadbolt lock is in a deadbolt locked position.

48. The arrangement of claim 47 wherein the user operable deadlock control trigger tab includes an untriggered configuration wherein the deadbolt holding arm remains captured within the deadlock activation tab and a triggered configuration wherein the deadbolt holding arm is in the uncaptured position no longer retained within the deadlock activation tab.

49. The arrangement of claim 48 wherein the configuration of the deadlock control trigger tab into the trigger configuration produces a lateral slidable engagement between the deadlock control trigger tab and the deadlock activation tab.

50. The arrangement of claim 49 wherein the deadbolt holding arm substantially at one end is pivotally supported upon the lower housing block and at a substantially opposing end includes a distal end notch which is able to be received within a receival slot defined within the deadlock activation tab when the deadbolt holding arm is in the captured position.

51. The arrangement of claim 50 wherein when the deadlock control trigger tab laterally slidably engages the deadlock activation tab when the deadlock control trigger tab is in the trigger configuration wherein lateral movement of the deadlock activation tab releases the notch of the deadbolt holding arm from the receival slot of the deadlock activation tab so as to bias the deadbolt holding arm away from the captured position to the uncaptured position.

52. The arrangement of claim 51 wherein the deadbolt holding arm includes a raised shoulder wherein an external skirt or edge of the raised shoulder provides for an interconnected engagement between a stem extending from the finger of the deadbolt release cam such that rotation of the deadbolt release cam in the second direction causes the interconnection engagement between the stem of the finger attached to the deadbolt release cam and the shouldered skirt or edge of the raised shoulder of the deadbolt holding arm to bias the deadbolt holding arm back into the captured position within the deadbolt activation tab.

53. The arrangement of claim 52 wherein the deadlock activation tab is in communication with a resilient spring biasing the deadlock activation tab to allow the receiving slot of the deadlock activation tab to slidably return to its receival engagement configuration with the deadbolt holding arm, when the deadbolt holding arm is returned to its captured position by the deadbolt release cam.
